(19) United States
(12) Patent Application Publication
(10) Pub. No.: US 2006/0277148 A1
(43) Pub. Date: Dec. 7, 2006

(54) Payment system and method for on-line commerce operations

(76) Inventor: James D. Thackston, Tampa, FL (US)

Correspondence Address: MCGUIREWOODS, LLP, 1750 TYSONS BLVD, SUITE 1800, MCLEAN, VA, 22102, US

(21) Appl. No.: 11/447,056

(22) Filed: Jun. 6, 2006

Related U.S. Application Data
(60) Provisional application No. 60/687,446, filed on Jun. 6, 2005.
(60) Provisional application No. 60/698,466, filed on Jul. 13, 2005.

(51) Int. Cl. G06Q 99/00; G06Q 40/00; H04L 9/00; H04K 1/00

(52) U.S. Cl. 705/41; 705/69

(57) ABSTRACT

A system and method provides for an independent provider of electronic “stored value” credit to enable a consumer of products and services to apply cash or cash equivalents to fund an electronic account, i.e., a stored value account (SVA), managed by an independent stored value provider (ISVP) in a network of ISVPs. The consumer is typically a customer of the ISVP. The applied funds may be used by the customer to purchase products and services from any of several merchants that have established a transactional business association with the ISVP. The merchants may also be any type of on-line e-commerce business and/or a traditional in-store business. Moreover, a customer may transfer funds from one SVA to another SVA. Customers may add funds to a SVA, in person, at a Retail Financial Service Provider (RFSP) who verifies the identity of the consumer. The system and method does not require traditional financial information such as bank accounts, social security information, credit card or debit card information thereby avoiding any possibility of misuse of this information by others. Age verification and identity verification is facilitated by the system.

### CROSS REFERENCE TO RELATED APPLICATIONS

This application claims benefit and priority to U.S. Provisional Application No. 60/687,446 filed Jun. 6, 2005 and to U.S. Provisional Application No. 60/698,466 filed Jul. 13, 2005, both disclosures being incorporated by reference herein, in their entirety. This application is also related to and being filed with U.S. patent application Ser. No. ______, entitled SYSTEM AND METHOD FOR ON-LINE COMMERCE OPERATIONS, which is incorporated by reference herein in its entirety.

### DESCRIPTION

1. Field of the Invention

The invention generally relates to a system and method to provision a secure payment for consumer purchases of products and services such as from on-line merchants and, more particularly, for making payments using a virtual stored value account.

2. Background of the Invention

In the course of engaging in Internet-based electronic commerce, consumers use a variety of payment options, including, most often, credit cards. Other common options include electronic debits from checking accounts and debit cards. In many cases, merchants require customers to enter their credit card, debit card, or checking account numbers on a web form and then submit the information over the Internet where it is typically verified and stored in a database managed by the merchant.

The possibility exists that a particular on-line merchant may not be operating honestly or within the law. There are many known cases where an on-line merchant that appears to the customer as being completely legitimate is actually operated by individuals intent on stealing unsuspecting customers' critical account numbers or otherwise defrauding consumers.

Since merchants must usually be granted access to payment service providers such as credit card processors, it is assumed by most consumers that merchants are properly screened. While the majority of merchants are completely legitimate and reputable, the number of merchants applying for access to monolithic, conventional credit card processing networks is so large that some dishonest merchants may be inadvertently granted access to the global payment infrastructure.

Another well-known shortcoming of existing e-commerce payment alternatives is the presence of hackers who are determined to breach the network security of legitimate on-line merchants and subsequently steal the contents of their customer databases. Hackers can easily cause damage to a consumer's credit profile by misusing any stolen personal information.

Yet another hazard is manifested in the many computer viruses and so-called spyware programs that are specifically designed to steal financial account numbers and other sensitive information directly from a consumer's infected computer. Among the various spyware programs, “keyloggers” are particularly malicious since these programs record and transmit the victim's keystrokes as typing occurs which may of course include sensitive information such as credit card numbers or personal data. Unfortunately, these events occur with enough frequency that many consumers are afraid to engage in on-line commerce for fear of losing control of their vital financial information, or worse, lose control over assets and credit worthiness.

In an e-commerce environment fraught with so many dangers, many consumers forgo electronic commerce transactions to avoid these risks. A substantially foolproof system and technique of protecting customers' financial information (such as credit card numbers, debit card numbers, bank account numbers, etc.) would be of substantial utility. Merchants and consumers alike would benefit.

Moreover, in addition to the prospects of criminals posing as legitimate merchants and hackers stealing from honest merchants, consumers with less than honorable intentions may use electronic payment systems to launder money. Some existing payment systems offer total anonymity and thus may be used to effectively launder money. An e-commerce payment system that enables positive identification of customers would represent a significant advancement in the prevention of money laundering and other illicit activities.

Additionally, there are a number of on-line merchants that offer products or services that are not appropriate for consumers under a certain age. Two such examples are on-line pharmacies and adult-oriented material. In recent years, much debate has been devoted to the issue of on-line wine merchants, for example. At the center of this debate is the inability of current electronic payment systems to accurately and reliably verify the age of on-line consumers. Clearly, any on-line payment technique that helps to accurately verify the age of customers would represent another significant advance in e-commerce.

### SUMMARY OF THE INVENTION

The invention satisfies the foregoing needs and avoids the drawbacks and limitations of the prior art by providing an apparatus, system and methods for providing an age verification and identity verification without jeopardizing confidential personal information such as credit card information or birth dates, for example. In particular, a computer-implemented method for selecting money amounts is provided. The computer-implemented method includes presenting a first list having a plurality of money ranges and receiving a selection of one money range from the plurality of money ranges. Further, the computer-implemented method includes presenting a second list having a plurality of money value increments wherein the plurality of money value increments are within the selected one money range and receiving a selection of one money value increment from the plurality of money increments for facilitating a money transaction.

Further, a method of controlling on-line sale for an age-restricted product or service is provided. The method includes the steps of receiving at an on-line merchant a request for a purchase or the age-restricted product or service, receiving at the merchant an indication that the identity of a consumer initiating the request has been verified by an authorized human agent based on at least a governmentally sanctioned identification document and fulfilling the request based on the indication.

Also, an age verification system to facilitate transactions of an age-restricted product or service involving an Internet payment processing business is provided. The age verification system comprises a first software module configured to receive age information from a human agent and a second software module that stores an age indicator of the consumer in a database record associated with the consumer. The age verification system also comprises a third software module that initiates transmission of an electronic signal including a first code identifying the consumer and an amount of a transaction. The first code also provides information for retrieving the database record to access the age indicator, wherein the age indicator is used to grant or deny the transaction of the age-restricted product or service.

Still further, a system for verifying and managing data in an on-line commerce system is provided. The system comprises means for issuing a prompt for a money value range and receiving a selection in response to the prompt to facilitate payment of an on-line purchase. The prompt includes a plurality of money ranges. The system further comprises means for receiving input indicating positive identification of a purchaser of the on-line purchase. The positive identification indicates that verification by a human agent as to the identity of the purchaser has been performed. The system further comprises means for initiating communication of information that the identity of the purchaser has been positively verified to an on-line merchant for authorizing completion of the on-line purchase.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a functional block diagram of an exemplary system, according to the principles of the invention;

FIG. 2 is a functional block diagram illustrating an embodiment of customer on-line interactions, according to the principles of the invention;

FIG. 3 is a block diagram of an embodiment of computer architecture for supporting the peer to peer network, according to the principles of the invention;

FIGS. 4A and 4B are flow diagrams of embodiments showing steps of using the invention;

FIG. 5 is a flow diagram of an embodiment showing steps of adding money to a stored value account, according to principles of the invention;

FIG. 6A is a flow diagram of an embodiment showing steps for a cash selection process, according to principles of the invention;

FIG. 6B is a flow diagram of an embodiment showing steps for dual authentication for cash receipt, according to principles of the invention;

FIGS. 7A-7C is an embodiment of a graphical user interfaces (GUI) for facilitating transactions at a retail financial services provider (RFSP), according to principles of the invention;

FIGS. 8A and 8B are flow diagrams of an another embodiment showing steps for dual authentication for cash receipt, according to principles of the invention;

FIG. 9A is a flow diagram showing steps of an embodiment for moving money from a customer account to a merchant, according to principles of the invention;

FIG. 9B is a flow diagram of an embodiment showing steps for cash amount selection process, according to principles of the invention;

FIG. 10 is a flow diagram of an embodiment showing steps of moving money between a customer ISVP account and a merchant, according to principles of the invention; and

FIGS. 11A and 11B are flow diagrams of an embodiment showing steps of synchronizing a merchant customer account and an ISVP customer account, according to principles of the invention;

FIG. 12A is a flow diagram of an embodiment showing steps of establishing merchant information in an ISVP database, according to principles of the invention;

FIG. 12B is a flow diagram of an embodiment showing steps of customer identity and age verification, according to principles of the invention;

FIG. 12C is a flow diagram of an embodiment showing steps of a counter agent customer identity age verification procedure using biometrics, according to principles of the invention;

FIG. 12D is a flow diagram of an embodiment showing steps of updating ISVP customer database record, according to principles of the invention;

FIGS. 12E and 12F is a flow diagram of an embodiment showing steps for a customer procedure to obtain a temporary transaction password, according to principles of the invention;

FIG. 13 is an exemplary illustration of a portion of an interface provided by the ISVP for various functions including identity and age verification, according to principles of the invention.

FIG. 14 is an exemplary illustration of a customer record, according to principles of the invention;

FIG. 15 is an exemplary illustration of a merchant record, according to principles of the invention; and

FIG. 16 is a flow diagram of an embodiment showing steps for receiving and communicating information in the system, according to principles of the invention.

### DETAILED DESCRIPTION OF EMBODIMENTS OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

In embodiments, the invention is generally directed to a system and method that provides for an independent provider of electronic “stored value” to enable a consumer of products and services to apply cash or cash equivalents to fund an electronic account, i.e., a stored value account (SVA), managed by an independent stored value provider (ISVP). The consumer is typically a customer of the ISVP. The applied funds may be used by the customer to purchase products and services from any of several merchants that have established a transactional business association with the ISVP. The merchants may also be any type of on-line e-commerce business and/or a traditional in-store business. Moreover, a customer may transfer funds from one SVA to another SVA. Customers may add funds to a SVA, in person, at a Retail Financial Service Provider (RFSP).

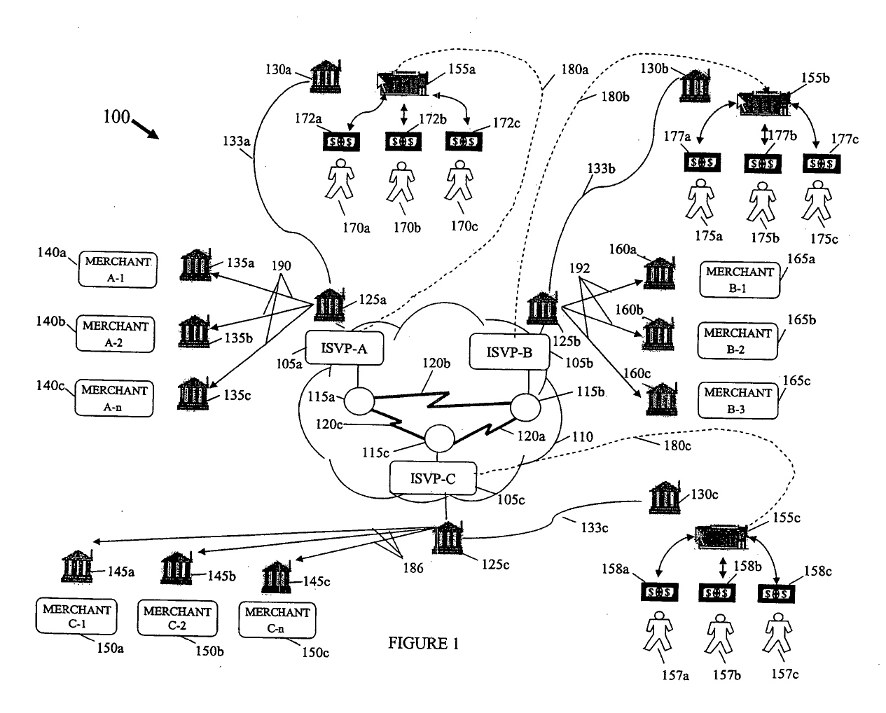

FIG. 1 is a functional block diagram of an exemplary system of the invention, generally denoted by reference numeral 100. ISVPs 105a-105c may be interconnected by a network 110, which may be the Internet or similar global computer network architecture. Each ISVP 105a-105c comprises a peer-to-peer software instance 115a-115c, respectively, that provides multiple functions including real-time communication interoperability among ISVPs 105a-105c, and may be layered on network 110. Typically, the ISVPs 105a-105c run substantially identical versions (subject to typical variations due to common incremental version upgrades and/or testing, for example) of software instances 115a-115b which enable the peer-to-peer network 120a-120c (generally, may also be referred to as “peer-to-peer network” 120) interoperability. The software instances 115a-115c facilitates sharing of data among ISVPS 105a-105c without need for special infrastructure, among other functions. Each ISVP 105a-105c typically has an associated web site accessible via the network 110.

The system 100 may also include banks 125a-125c, which are typically associated with ISVPs 105a-105c, respectively. Each ISVP 105a-105c in the peer-to-peer network 120 maintains one or more bank accounts that are independent from those of every other ISVP in the peer-to-peer network 120. All funds taken in from the various Retail Financial Services Providers (RFSPs), 155a-155c, are held in trust in these bank accounts. By contractual decree and by the rules of trust accounts, ISVPs 105a-105c may not redirect, invest, or otherwise utilize the funds held in trust. An ISVP 105a-105c may move funds from ISVP bank accounts only in the course of fulfilling a legitimate payment request from a merchant, a funds transfer between SVAs at the command of any authorized customer 170, 175 or 157 (generally, customer 170 refers to any customer 170a-170c associated with ISVP 105a, customer 175 refers to any customer 175a-175c associated with ISVP 105b, and customer 158 refers to any customer 158a-158c associated with ISVP 105c) or fulfilling a redistribution request at the command of the customer 157, 170 or 175.

Each of the RFSPs, 155a-155c, may be any type of business or organization that offers services such as, for example, payroll check cashing services, short term loans, wire transfers, money order sales, or a variety of other related services such as financial services or insurance services, from a physical location wherein a customer may interact with a live person. Moreover, the RFSP may be any physical place of business such as a bank branch or shipping company, such as, for example, United Parcel Service (UPS) or Federal Express (FedEx), where a counter agent may be present. The terms “counter agent” and “agent” are used interchangeably to refer to the live person which is typically an employee actor of an RFSP 155a-155c. Additionally, each RFSP 155a-155c has a business obligation, consummated through contracts with one or more ISVPs 105a-105c, to receive monetary value from a respective ISVP customer 170, 175 or 157. Each RFSP 155a-155c may have an affiliated bank 130a-130c, respectively, for facilitate receipts and deposits for business related transactions. The banks 130a-130c may be interconnected with other banks such as 125a-125c by traditional banking networks 133a-133c.

Moreover, RFSPs 155a-155c are usually obligated by contract to ensure that the identity and age of the ISVPs' 105a-105c customers 157, 170 or 175 are verified using commonly accepted identification means such as a driver's license, military ID, passports, or any other effective identifying measure. Additionally, an RFSP 155a-155c may communicate bi-directionally in real-time with one or more host ISVPs 105a-105c through an electronic connection, perhaps network 110 and/or another network or networks 180a-180c. This electronic connection 180a-180c ensures that as an RFSP counter agent interacts with an ISVP customer 157, 170 or 175, the associated ISVP 105a-105c can provide the agent with immediate feedback information and ensures that transaction information is properly recorded in the ISVPs' 105a-105c databases while the customer is in the physical business location. After all electronic communication between an RFSP 105a-105c and an ISVP 105a-105c is verified as complete during a transaction, a transaction receipt bearing a transaction record locator code is distributed to the customer before the customer leaves the RFSP 105a-105c location.

Each ISVP 105a-105c may operate as a node on the peer-to-peer network 120, or similar type of network. A customer 157, 170, 175 may add funds (e.g., 172a-172c, 177a-177c or 158a-158c) to a stored value account (SVA) at any one of several physical business locations, such as RFSP 155a-155c, that are entrusted by one or more ISVPs 105a-105c to manage the receipts.

Each participating merchant, 140, 150, and 165 (generally, merchant 140 includes any merchant 140a-140c having a business relationship with ISVP 105a, merchant 150 includes any merchant 150a-150c having a business relationship with ISVP 105c and merchant 165 includes any merchant 165a-165c having a business relationship with ISVP 105b) may have a business relationship with one and only one ISVP 105a-105c on the peer-to-peer network 120. Each merchant 140a-140c, 150a-150c and 165a-165c typically has an associated bank 135a-135c, 145a-145c and 160a-160c, respectively, for business type banking accounts and transactional support.

In addition to facilitating merchant-industry specialization among ISVPs 105a-105c, this merchant-ISVP relationship also enables each ISVP 105a-105c to properly screen would-be merchants before establishing a business relationship and allowing them to become part of the system 100. In general, this screening then aids in reducing the potential that customers might be exposed to merchants that are not capable of providing acceptable levels of service or even to merchants with criminal intent. Screening of merchants by ISVPs 105a-105c also aids in ensuring that every merchant 140, 150, 165 involved with any ISVP 105a-105c in the peer-to-peer network 120 is a viable legal business entity and is operated by legitimate interests operating entirely within applicable laws and that it is fairly offering products and services at a reasonable price. By way of one non-limiting example, a particular ISVP 105 may be associated with antique buyers and sellers. The ISVP may screen these merchants to help assure that only reputable antique dealers are part of the system 100.

Moreover, since the SVA of an ISVP 105a-105c is typically funded at a physical business location (i.e., RFSP 155a-155c), the identity, age, and/or credit worthiness of potential customers may be effectively verified. Thus, the system 100 also provides for reduced possibility that criminals or terrorists can utilize on-line commerce (or in-store commerce) as a means to launder money or finance terrorist elements.

Furthermore, since none of a customer's sensitive financial information such as credit card numbers, debit card numbers or bank account numbers is ever collected by the ISVPs 105a-105c, there is no possibility that such customer's sensitive financial information would ever fall into the hands of unauthorized individuals should any part of the peer-to peer network 120 and associated elements be compromised. Since the ISVPs 105a-105c do not rely on, require, store or track such customer's sensitive financial information, the possibility of unauthorized access to this information is not possible. Therefore, customer identity fraud based on credit card numbers, debit cards or bank accounts is avoided.

An ISVP 105a-105c is empowered to independently manage SVAs on behalf of their consumers 170, 175, 157 for the purpose of facilitating secure payments to on-line (and/or in-store) merchants 140, 150, 165 that ISVP customers 170, 175, 157 may wish to patronize. An ISVP 105a-105c is often responsible for cultivating relationships with on-line merchants and ensuring that any merchants brought into the ISVP network is screened for levels of viability, integrity and/or reliability before being deemed suitable for inclusion in the system 100.

ISVPs 105a-105c may be segregated according to industry expertise. For example, ISVP-A 105a may handle only on-line retailers such as on-line retailer Amazon®, for example, while ISVP-B 105b may specialize in managing payments to on-line (or in-store) business services. Any ISVP 105a-105c may be empowered to develop business relationships with any number of potential or actual RFSPs so that a customer can apply funds to their SVA. Also, an ISVP 105a-105c is typically responsible for managing overnight electronic funds transfers (EFTs) from a bank account of an ISVP's bank 125a-125c to the bank accounts of the various respective merchants 140, 150, 165.

Accounts

An SVA is a product offering of an ISVP 105a-105c. The value in an SVA may be deposited or applied by an authorized customer 157, 170, 175 through an appropriate RFSP 155a-155c and may be considered a “credit-in-trust,” typically requiring that the funds are held indefinitely according to the directives of the customer. SVA funds are not invested or in any way utilized except as directed for purchasing products and services from on-line merchants (or in-store merchants), redistribution back to the customer, or transfer to another SVA. A customer 157, 170, 175 has the option of deactivating their SVA. No new funds may be added to a deactivated account and merchants 140, 150, 165 cannot debit a deactivated SVA. Moreover, customers 157, 170, or 175 have the option of selectively barring merchants 140, 150 or 165 from applying debits against an active SVA.

Any customer 157, 170, or 175 may at any time request that some or all of the funds in their SVA be cashed out. Disbursement may be in the form, for example, of a check mailed to an address specified by the customer or in the form of cash dispensed by any RFSP 155a-155c affiliated with a relevant ISVP or ISVPs 105a-105c. To reduce many laundering opportunities, it may be required that all disbursements of funds be made by check and that reports be made to appropriate regulating agencies.

When a customer 157, 170, or 175 applies cash at an appropriate RSFP 155a-155c, the credit appears almost immediately in the SVA to which the credit was directed. In some cases, if funds are applied with a non-cash instrument such as a check, funds may not be applied until the check clears.

System 100 also provides for detailed transaction records to provide complete traceability for every action taken by any customer 157, 170, 175, any RFSP 155a-155c, any merchant 140, 150, 165 or any ISVP 105a-105c that affects a SVA. A SVA may be used by a customer to “push” money to a merchant 140, 150, 165, if the merchant allows this payment method. The system 100 may also provide for a customer 157, 170, 175 to transfer funds between more than one SVA that a customer has established and controls. Funds cannot be removed from a SVA that is owned by another customer.

The peer-to-peer network 120 also facilitates sharing of customer SVAs that are designated as “universal” accounts by “native” customers (discussed below) of any of the ISVPs 105a-105c. A Universal Stored Value Account (USVA) is a SVA designated by the “native” customer of a “home” ISVP to be shared among all ISVPs 105a-105c in the peer-to-peer network 120. A USVA customer is known as a shared customer.

By way of example, an ISVP, e.g., 105a, with whom a customer, e.g., 170a, opens a SVA, typically provides payment services to a limited number of merchants, such as 140a-140c. However, the ISVP customer 170a may choose to purchase products and services from a broad variety of merchants, other than 140a-140c, many of whom may be serviced by an ISVP, such as 105b and 105c, in the peer-to-peer network 120 other than the customer's home ISVP 105a. The USVA enables the customer 170a to buy from any merchant 140, 150, 165 affiliated with any ISVP 105a-105c, in the peer-to-peer network 120. The peer-to-peer network 120 synchronizes the USVA in real-time.

Since all ISVPs 105a-105c are aware of all USVAs, due to the real-time synchronization functionality of the peer-to-peer network 120, customers 170, 175, 157 may request withdrawal of funds from a USVA at any RFSP 155a-155c affiliated with any ISVP 105a-105c.

By way of another example, it may be necessary to provide for a customer, e.g., 157a (associated with home ISVP 105c), who makes purchases from an on-line merchant 150a, also associated with ISVP 105c, to also be able to pay a power bill from a power company (not shown) managed by a different ISVP, perhaps 105a, for example. When customer 157a uses a shared account (i.e., USVA), the associated home ISVP, i.e., 105c in this example, is responsible for managing overnight electronic funds transfers (EFTs) from the appropriate ISVP bank account (i.e., from bank 125c) to the bank accounts of any other ISVP in the peer-to-peer network 120 requiring settlement for purchases. This EFT necessarily involves bank 125a and ISVP 105a in this illustrative example, since the exemplary power company is associated with ISVP 105a.

When an ISVP customer 170, 175, 157 first opens a SVA, the ISVP 105a-105c with whom the customer 170, 175, 157 establishes the first account is called a “home” ISVP. Any other ISVPs 105a-105c having relationships with merchants 140, 150, 165 from whom the home ISVP customer wishes to purchase products or services is called a “host” ISVP.

In contrast to a USVA, a SVA may be designated as a Local Stored Value Account (LSVA) and may only be used to purchase products and services from merchants having a business relationship with the “home” ISVP. The other ISVPs in the peer-to-peer network 120 have no knowledge of a home ISVP LSVA. When an ISVP customer chooses to withdraw funds from a LSVA, only the home ISVP may disburse funds in the form of a mailed check and only those RFSPs affiliated with the home ISVP may disburse withdrawn funds in the form of cash or cash equivalents.

In embodiments, a website of any one of the ISVPs 105a-105c in the peer-to-peer network 120 may be visited by a prospective new customer to learn about the services available from system 100. When the prospective customer creates an account with the visited ISVP 105a-105c, the customer is considered “native” to the “first engaged” ISVP which, with respect to the native customer, is the “home” ISVP. When the native customer first opens an account with the home ISVP, the native customer may choose to make their SVA account visible to all of the other ISVPs 105a-105c in the peer-to-peer network 120 by way of a universal designation.

A native customer may purchase products and services from any merchant that has established a business relationship with the home ISVP.

A native customer cannot purchase from a merchant that does not have a business association with the home ISVP even if that merchant has a business relationship with another ISVP in the peer-to-peer network 120. A native customer can have one and only one home ISVP. Moreover, a native customer may create multiple SVAs at the home ISVP. A native customer may only view complete account and transaction summaries for all ISVP purchases, host or home, on the home ISVP's web site.

However, a shared customer may view account and transaction summaries for only those merchant transactions involving merchants having a business relationship with the particular host ISVP engaged by the shared customer. But, a shared customer may view complete account and transaction summaries for all ISVP purchases, host or home, only on the home ISVP's web site.

Merchants Accepting Payments

Any merchant 140, 150, 165 may use the peer-to-peer network 120 of ISVPs 105a-105c to accept payments from customers 170, 175, 157 in exchange for products and services. A merchant 140, 150, 165 may choose to allow customers 157, 170, 175 to “push” money into a merchant account.

Most often, a merchant 140, 150, 165 may debit a customer's SVA, at the customer's command, in a way analogous to conventional credit card or debit card transactions, but without involving credit or debit cards.

Monetary Value Applied to ISVP Accounts

A native customer may add funds to a LSVA using any form of monetary value accepted by any RFSP 155a-155c associated with the customer's home ISVP 105a-105c. A shared customer may add funds to a USVA using any form of monetary value accepted by any RFSP 155a-155c associated with any ISVP 105a-105c in the peer-to-peer network 120.

Cash may be the preferred funding instrument since taking in cash helps the receiving RFSP 155a-155c with cash-on-hand logistics. When the funds applied are in cash, the credit is immediately posted to the appropriate SVA. Other funding alternatives, such as a check draft, typically require clearance before any credit is applied.

A RFSP counter agent verifies the identity and, when necessary, age of the customer prior to accepting any funding instrument. A two-party identity verification system may be used to authenticate the funding transaction and customers 170, 175, 157 may be given a receipt containing a transaction record locator code once the funding transaction is complete. In some embodiments, verification of identity may also require passing a biometric measurement such as a fingerprint, a voice-print, a facial scan, a retina scan or other commonly known biometric.

Independent Stored Value Provider Bank Accounts

Each ISVP 105a-105c in the peer-to-peer network 120 maintains one or more bank accounts that are independent from those of every other ISVP 105a-105c. All funds taken in from the various RFSPs 155a-155c are held in trust in these bank accounts. By contractual decree and by the rules of the trust accounts, ISVPs 105a-105c may not redirect, invest, or otherwise utilize the funds held in trust. An ISVP 105a-105c may move funds from the ISVP bank accounts only in the course of:

i) a funds transfer between SVAs at the command of the customer 170, 175, 157;

ii) fulfilling a redistribution request at the command of the customer 170, 175, 157; or

iii) fulfilling a legitimate payment request from a merchant 140, 150, 165.

Merchant Bank Accounts

The merchant bank accounts associated with merchants 140, 150, 165 may be characterized as somewhat “passive.” That is, the merchant bank accounts receive funds transfers from appropriate ISVPs' bank accounts at regular intervals in the course of settling debits and credits made against customer accounts managed by the ISVPs 105a-105c.

RFSP Bank Accounts

In the course of receiving money on behalf of one or more ISVPs 105a-105c, electronic funds transfers (EFTs) may be made at regular intervals from the RFSP bank account(s) to the appropriate ISVP bank account. Since many funds taken in by an RFSP 155a-155c may be used immediately by the customer, EFTs are typically executed every 24 hours, or at some other appropriate interval, to ensure the minimum possible float burden on the ISVPs 105a-105c.

Customer Interactions

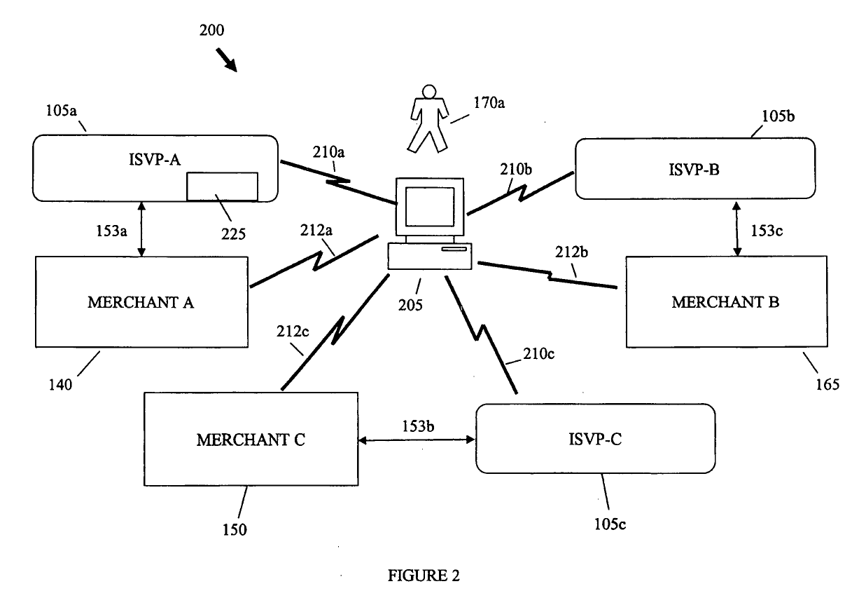

FIG. 2 is a functional block diagram illustrating an embodiment of customer on-line interactions, generally denoted as reference numeral 200. By way of example, customer 170a (at certain times, a potential customer) may employ a computing device 205, such as a personal computer, to establish a session 210a to access a home ISVP 105a web site, typically using a browser, to learn about the independent banking-like services provided by the invention or perhaps to establish a SVA 225, access a SVA 225 or request action regarding a SVA 225.

Moreover, according to the example, the customer 170a may optionally establish sessions 210b, 210c to host ISVPs' 170b, 170c, web sites to transact business in accordance with host-customer privileges based on established customer account types such as local or universal. Sessions 210a-210c and 212a-212c may be established via the Internet or similar global network. The sessions may contain applets or similar computer code embedded in a carrier wave for transacting business, according to the invention.

Further, in the course of establishing and interacting with a SVA 225 managed by an ISVP 105a-105c, the customer 170a may use any computing device 205 capable of interactive, real-time communication with an ISVP 105a-105c. All manner of common devices such as, but not limited to, laptop or notebook computers, cell phones, hand-held PDA computers, desktop computers, Internet kiosks, tablet or pen-based computers, may be used.

Continuing with the example, similar to the customer-ISVP interaction, electronic communication between the customer computing device 205 and a merchant's 140, 150, 165 on-line web site may be accomplished by sessions 212a-212c. Purchases may be accomplished on-line and authorized for payment by customer 170a to a merchant 140, 150, 165. In embodiments, the merchant 140, 150, 165 may also be an in-store merchant, so that the transaction could occur on-premise. The merchant 140, 150, 165 may process the payment via the merchant's associated ISVP 105a-105c where funds are transferred from the customer's 170a SVA 225 (which may be a USVA) to the appropriate merchant's 140, 150, 165 account. Communication interfaces 153a-153c couple the ISVPs 105a-105c to respective merchants 140, 150, 165, which may be a common network, such as the Internet.

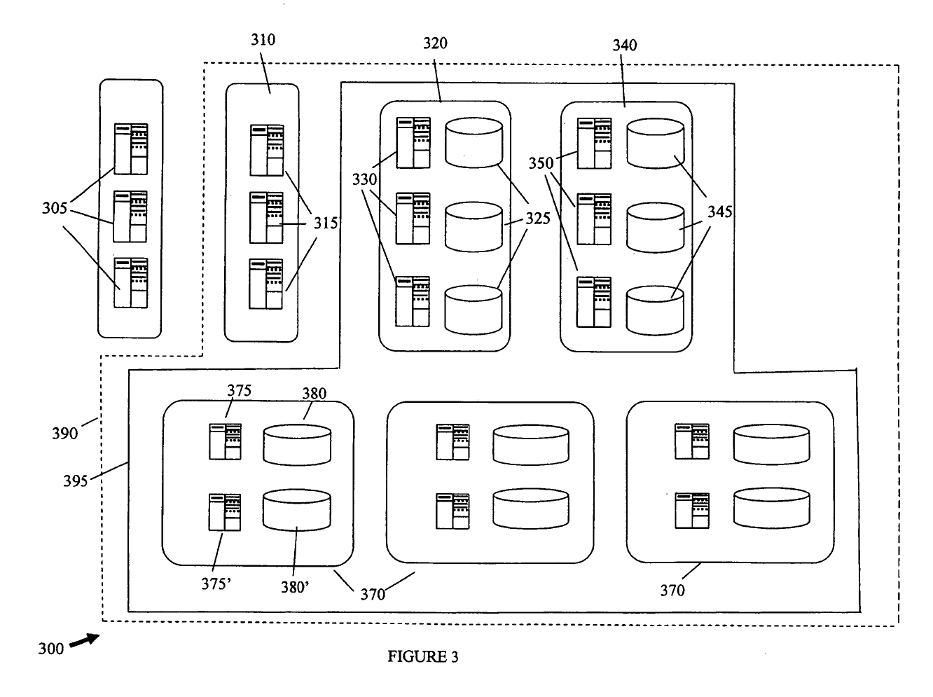

FIG. 3 is a block diagram of an embodiment of computer architecture for supporting the peer to peer network 120 and associated operations, generally denoted as reference numeral 300. A skilled artisan would recognize that other architectures may be possible and may be used by the invention and that this illustrative embodiment is just one example.

The architecture 300 also includes appropriate software for such functions as communications, web services, transactional processing and database management. The architecture 300 may be replicated at each ISVP 105a-150c in support of various system-wide activities and each ISVP 105a-105c operations. The architecture 300 may also comprise one or more public web servers 305 outside of the outside firewall 390. Inside of the outside firewall 390, but outside of inner firewall 395 may be an application tier that includes a cluster 310 of one or more servers 315 for applications.

Further, the architecture 300 may also comprise within the inner firewall 395, one or more transactional clusters 370 having one or more servers 375 and corresponding transactional databases 380. One server 375 and transactional database 380 may be designated as primary while a second server 375′ and transactional database 380′ may be designated as failover (backup). Also within the inner firewall 395, a customer database cluster 320 for maintaining customer related records comprising one or more servers 330 and associated customer databases 325 may be provided. Similarly, a merchant cluster 340 for maintaining merchant records may be provided comprising one or more servers 350 and associated databases 345.

### USING THE INVENTION

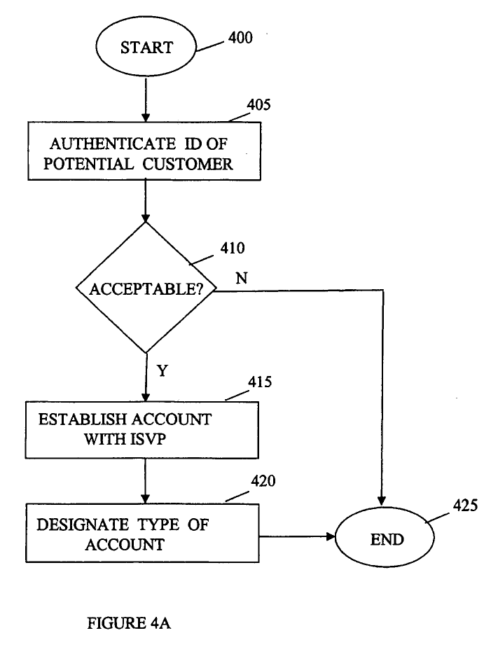

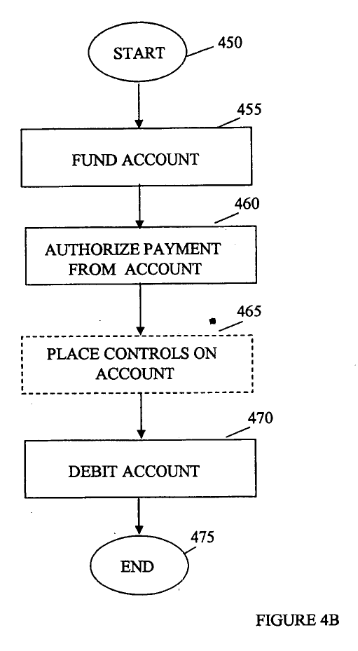

FIGS. 4A and 4B are flow diagrams of embodiments showing steps of using the invention, starting at steps 400 and 450, respectively. FIGS. 4A and 4B (and all of the other flow diagrams) may equally represent a high-level block diagram of components of the invention implementing the steps thereof. The steps of FIGS. 4A and 4B (and all of the other flow diagrams) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Further the computer code may also be embodied in a medium, at least in part, such as a carrier wave. Additionally, the computer program code and any associated parametric data can be transferred to a workstation over the Internet or some other type of network, perhaps encrypted, using a browser and/or using a carrier wave. The steps of FIGS. 4A and 4B (and the other flow diagrams) may also be implemented by the embodiments of FIGS. 1-3.

Continuing with FIG. 4A, at step 405 a potential customer may want to establish a SVA with a home ISVP. The potential customer may be authenticated by verifying identity using recognized identification techniques such as a passport, driver's license, governmental sanctioned document, or the like. This authentication may be performed by an agent at an RFSP associated with the home ISVP.

At step 410, a check may be made if the identification criteria of the ISVP has been met and is acceptable. If not, then the potential customer may be denied a SVA and the process ends at step 425. Otherwise, if the identification is deemed acceptable, at step 415, a SVA may be established with the home ISVP. The customer may also be provided (or alternatively, the customer provides) a unique identifier for subsequent access to their SVA account. At step 420, the account type may be designated as a local SVA or universal SVA. At step 425, the process ends.

Referring to FIG. 4B, at step 455, a SVA may be funded with cash, cash equivalents, or the like. Whenever a customer funds a SVA, identification of the customer may be performed by the RFSP as part of the RFSP responsibilities. Furthermore, since the RFSP may also be in a financial service business themselves, the account may be funded through a separate agreement with the RFSP, such as a loan. The RFSP may also provide a service to provide funds on behalf of the customer whenever the SVA has been overdrawn, according to any separate agreement between the RFSP and customer.

At step 460, a customer may authorize a payment to a merchant for a product or service. At optional step 465, at the discretion of the customer and often independent of certain other steps, controls may be placed on the SVA account such as, for example, to prevent any debits from being applied to the SVA, deactivating an account, or to prevent disbursements from being made from the SVA. At step 470, the SVA may be debited by the ISVP to satisfy a payment to a merchant.

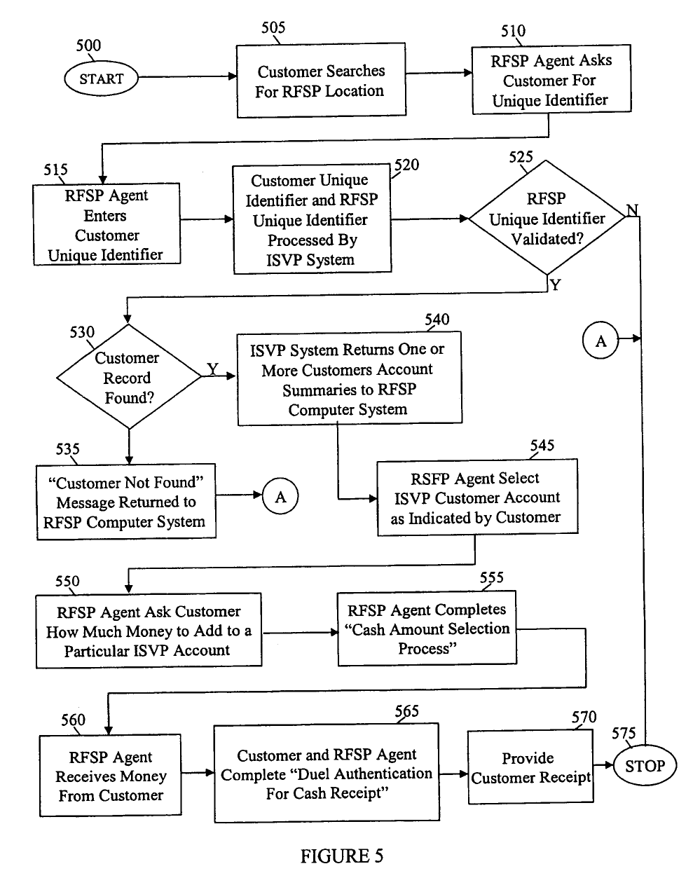

FIG. 5 is a flow diagram of an embodiment showing steps of adding money to a stored value account, starting at step 500. At step 505, a customer searches for a RFSP location, preferably an interactive lookup and mapping features on a ISVP web site. At step 510, a RFSP may ask a customer for a unique identifier known by the customer and ISVP such as, for example, an email address, account number, or pass code. At step 515, the RFSP agent enters the unique identifier into a terminal that is connected through software and a communication link to the ISVP.

At step 520, at a command of the RFSP agent, the unique customer identifier and RFSP unique identifier are sent to the ISVP for validation. At step 525, at the ISVP, a check is made whether the RFSP unique identifier is valid and originated from a valid and authorized RFSP. If not, the process terminates at step 575.

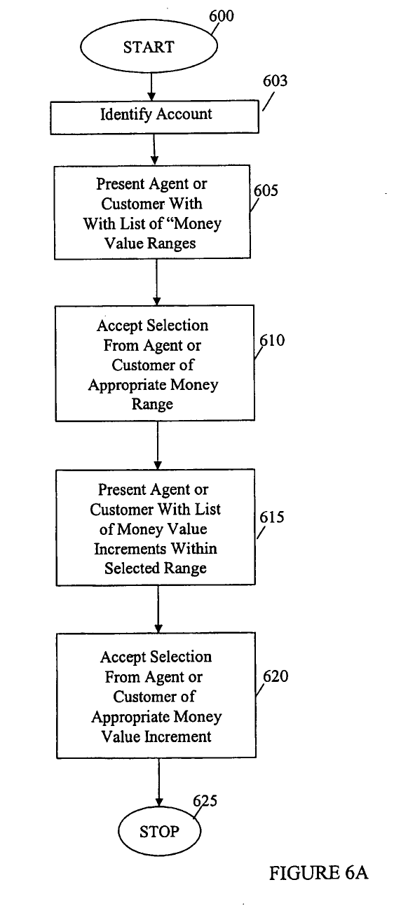

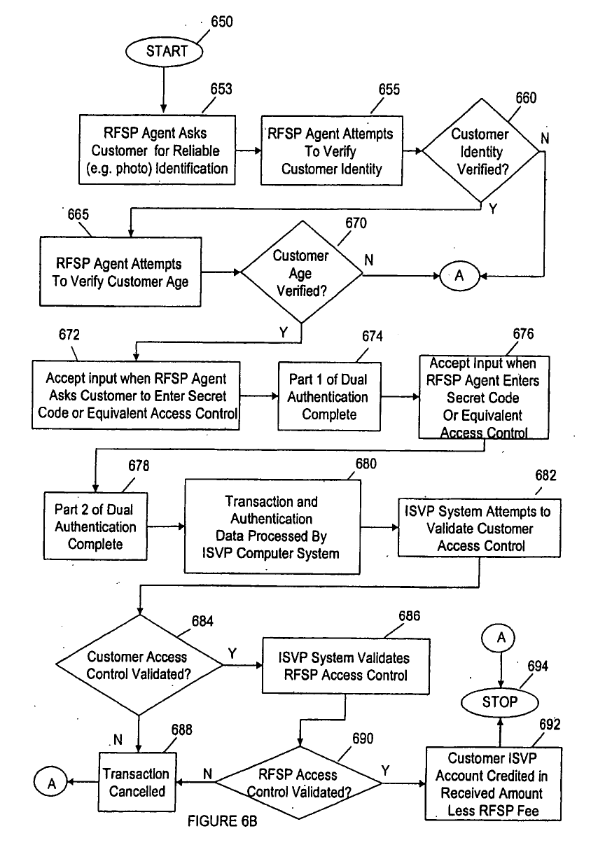

However, if the RFSP unique identifier is validated, then a check is made whether a customer record exists for the unique customer identifier. If the record is not found, then a message is returned to the RFSP computer to convey that no customer record exists and the process ends, at step 575. Otherwise, if the customer record is found, then at step 540, the ISVP returns one or more customer SVA summaries to the RFSP computer for display. At step 545, the agent selects an ISVP account per the customer's indication. At step 550, the agent asks the amount of money to add to the SVA. At step 555, a graphical user interface (GUI) may prompt for value ranges of money to complete a “cash amount selection process,” as explained in reference to FIG. 6A. At step 560, the agent receives money or money equivalents from the customer. At step 565, the customer and agent complete a “dual authentication for cash receipt,” as explained in conjunction with FIG. 6B. At step 570, a customer receipt is provided. At step 575, the process ends.

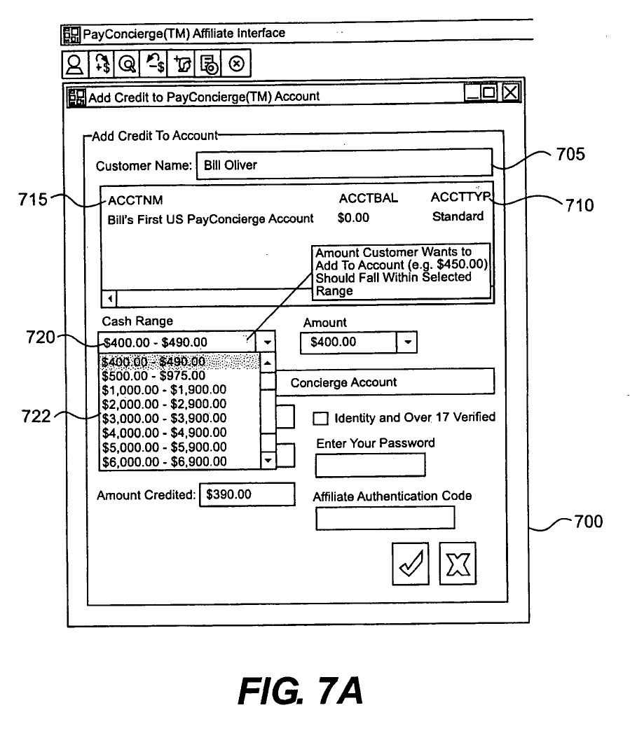

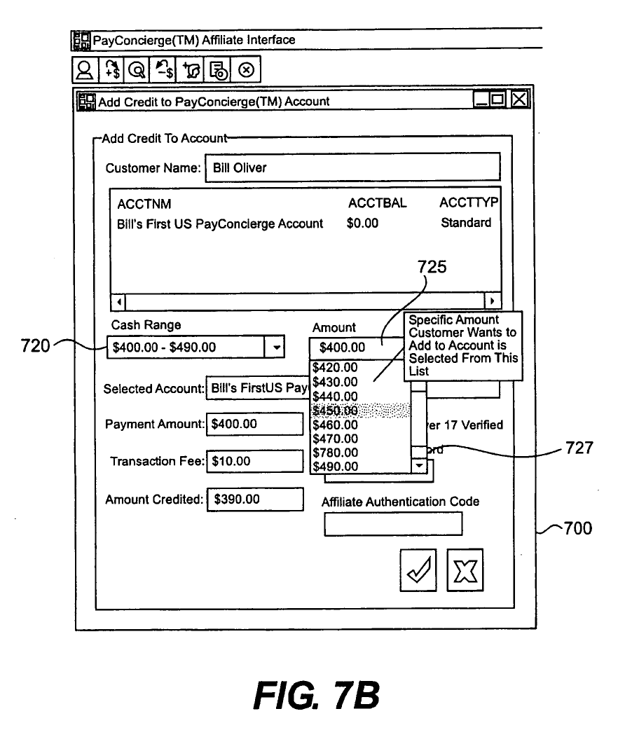

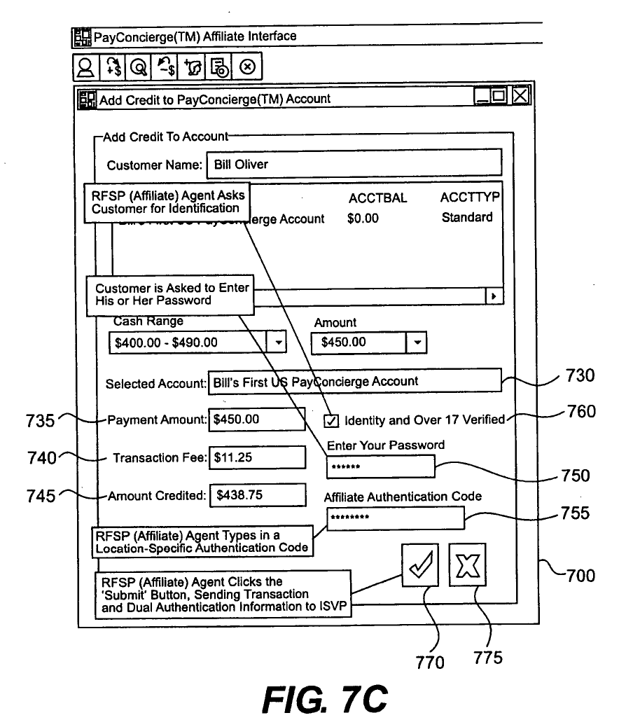

FIG. 6A is a flow diagram of an embodiment showing steps for a cash selection process, starting at step 600. The steps of FIGS. 6A and 6B may be considered in view of FIGS. 7A and 7B which illustrates an embodiment of a GUI for facilitating many of the steps. At step 603, an account may be identified for a transaction, which may be provided by the customer. At step 605, a list of money value ranges (e.g., FIG. 7A, 722) may be presented to the agent or customer, typically for a transaction associated with the account. At step 610, the selection of money value range is accepted. At step 615, in response to the selection of the money value range, a list of money value increments (e.g., FIG. 7B, 725 and 727) may be presented to the agent or customer, according to the money value range (FIG. 7B, 720). At step 620, a selection of the appropriate money value increment may be accepted for adding to the customer's SVA.

FIG. 6B is a flow diagram of an embodiment showing steps for dual authentication for cash receipt, starting at step 650. At step 653, an agent asks a customer for reliable identification, typically a drivers license, passport or other picture based identification. At step 655, the agent attempts to verify the identification to assure that the correct and authentic person is accessing the SVA. At step 660, a decision is made by the agent whether the customer identity has been verified. If the identity is deemed not verified, then the process ends, at step 694. If, however, the agent deems that the customer identity has been verified, then at step 665, the agent attempts to verify the customer's age based on the identification. This provides assurance that transactions that require a certain age (e.g., 21 years old for purchasing wine) has been verified. At step 670, a decision is made by the agent whether the age has been adequately verified and indicated to the system (e.g., FIG. 7C, 760). If the age is deemed not verified or not adequate for a particular transaction, then the process ends, at step 694.

If, however, the age is deemed verified, then at step 672, a customer entered secret code (e.g., FIG. 7C, 750) or equivalent access control (e.g., biometric data entry such as fingerprints, voiceprint, or eye scan) is accepted when entered by the customer, under direction of the agent and/or GUI prompts. At step 674, a first stage of the dual authentication entry is deemed complete. At step 676, a RFSP agent entered secret code (e.g., FIG. 7C, 755) or equivalent access control (e.g., biometric data entry) may be accepted when entered. At step 678, the second stage of dual authentication entry is deemed complete.

At step 680, the dual authentication data may be transmitted (e.g., via submit button 770 of FIG. 7C) to the ISVP and processed. At step 682, the ISVP attempts to validate the customer access control data. At step 684, a decision is made whether the customer access control data is valid. If not, the transaction is cancelled with appropriate messages returned to the RFSP indicating the cancellation. The process then ends at step 694.

If, however, the customer access information is deemed validated, then at step 686, the ISVP attempts to validate the RFSP access control information entered by the agent. At step 690, a decision is made whether the RFSP access control information is valid. If the RFSP access information is deemed not valid, the transaction is cancelled with an appropriate message to the RFSP and the process ends, at step 694.

If, however, the RFSP access control is deemed valid, then at step 692, the customer's ISVP SVA is credited with a received amount less any RFSP fee. A transaction status message may also be sent to the originating RFSP. The process ends at step 694.

FIGS. 7A-7C is an embodiment of a graphical user interfaces (GUI) for facilitating transactions at a RFSP, generally denoted as reference numeral 700. The GUI 700 may be used in conjunction with the steps of FIGS. 6A and 6B. The GUI 700 may include a field for identifying a customer name 705 and a field to identify the account type 710, such as standard, local, or universal, which the customer may supply on request. The GUI 700 may also include fields to indicate the particular account name 715 and a cash range 720 (or value range) prompt field with an associated drop down list 722. An amount field 725 may also be provided to indicate a chosen money increment amount within the money value range of cash range 720. The cash range 720 and associated drop down list 722 along with the money value range 725 and associated drop down list 727 aid in reducing data input errors for money amounts by both the agent and customer. The lists 722 and 727 limit any entry errors by avoiding misplacement of decimal points such as might occur when using other direct input techniques. Money denominations may be in any currency.

The GUI 700 may also include a selected account field 730, a payment amount 735, as selected, a transaction fee amount field 740, and an amount credited field 745. The GUI 700 may also include a password field 750 (or field to enter a secret code), an RFSP affiliate authentication code field 755, and a field 760 to indicate whether the identify and/or age has been verified for the transaction. The actual age requirement may vary per transaction based on pertinent law and product or service involved in the transaction (e.g., in one transaction, age 18 may be required such as for buying a tobacco product, whereas in another transaction, age 21 may be required such as for buying wine). A button 770 for submitting the transaction for authentication may also be provided as well as a button 775 for canceling a transaction.

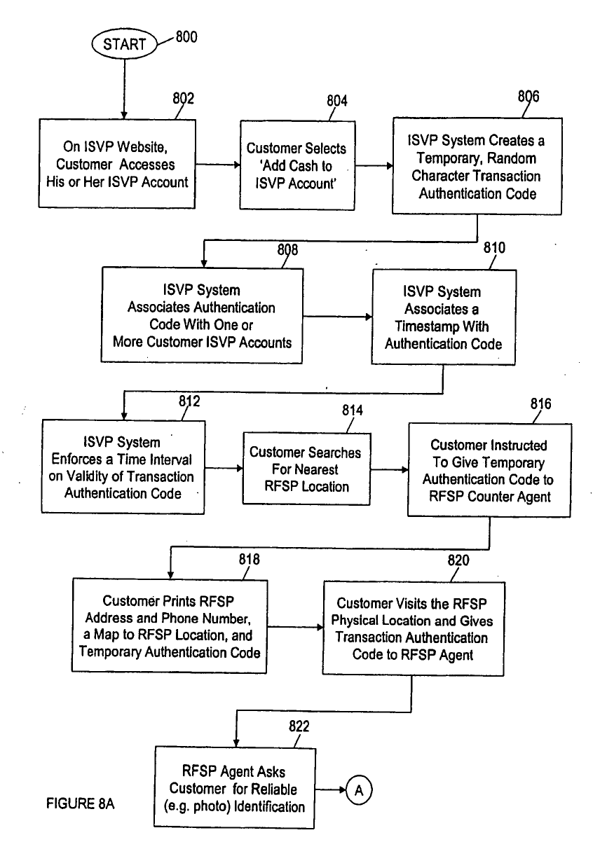

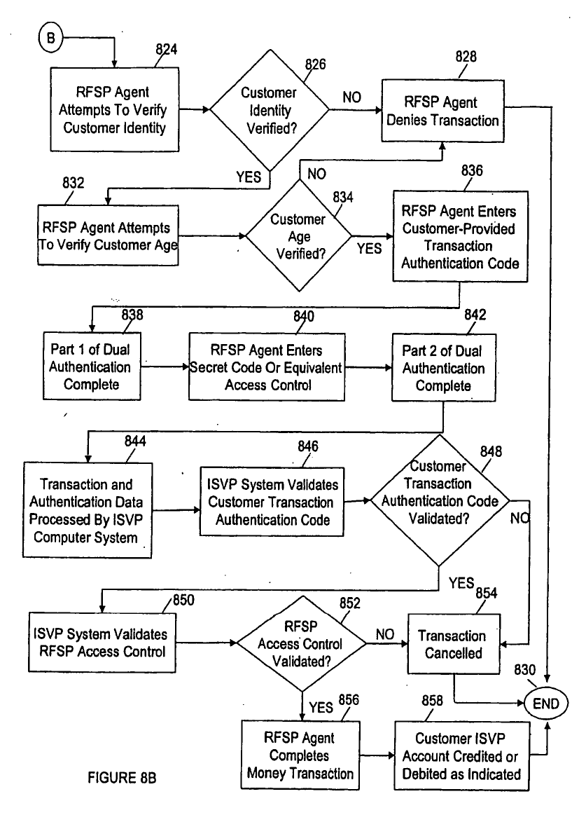

FIGS. 8A and 8B are flow diagrams of an another embodiment showing steps for dual authentication for cash receipt, starting at step 800. At step 802, a customer may access their ISVP account, typically via a web site associated with an ISVP, using a browser or similar interface. At step 804, the customer may select an option to “Add Cash to ISVP Account”, the option typically presented as a choice in a graphical user interface (GUI). At step 806, the ISVP system may create a temporary, random character transaction authentication code. At step 808, the ISVP system may associate the transaction authentication code with one or more customer ISVP accounts. At step 810, the ISVP associates a timestamp with the temporary transaction authentication code. At step 812, the ISVP system enforces a pre-determined time interval on the validity of the authentication code. The time interval may be several hours, one or more days or even weeks, as established by ISVP management policy. The transaction authentication code and timestamp are stored for subsequent recall.

At step 814, the customer searches, if necessary, for the “nearest RFSP location,” typically using a location finder function provided by the ISVP. At step 816, the customer may be instructed by the web site to provide the temporary authentication code to a RFSP agent at the “nearest RFSP location.” At step 818, the customer may print the “nearest RFSP” address and location map, perhaps along with the temporary transaction authentication code. At step 820, the customer visits the “nearest RFSP” location and provides the temporary transaction authentication code to a RFSP agent. At step 822, the RFSP agent asks the customer for reliable identification (e.g., a photo ID).

Continuing with FIG. 8B, the RFSP agent attempts to verify the customer identity based on the proffered photo ID. At step 826, a decision is made by the RFSP agent whether the customer has been verified. If deemed verified, then at step 828, the RFSP agent denies the transaction and the process terminates at step 830.

If, however, the customer's identity is deemed verified, then at step 832, the RFSP agent attempts to verify the customer age. At step 834, a decision is made whether the age has been verified. If not deemed verified, then processing continues at step 828 where the transaction is denied. If, however, the customer age is deemed verified, then at step 836, the RFSP agent may enter the customer provided temporary transaction authentication code. At step 838, a first stage of the dual authentication is considered complete. At step 840, the RFSP agent enters a secret pass code, swipes a is encoded ID card, or similar access control (such as, for example, a biometric input). At step 842, a second stage of the dual authentication is considered complete.

At step 850, the ISVP system receives the RFSP access control information (i.e., the RFSP agent's secret code or access control information) and validates the RFSP access control information to assure that the information is deriving from a correct and valid RFSP location. At step 846, the ISVP validates the received customer temporary transaction authentication code by checking with prior stored information. At step 848, a check is made whether the customer provided transaction authentication code has been validated. If not deemed validated, then at step 854 the transaction is terminated and the process ends at step 830. If, however, the customer provided transaction authentication code has been validated, then at step 856, the RFSP is informed of the validation and the RFSP completes the monetary transaction which may include accepting cash or cash equivalents. At step 858, the customer ISVP account may be credited, or debited, as appropriate. At step 830, the process ends.

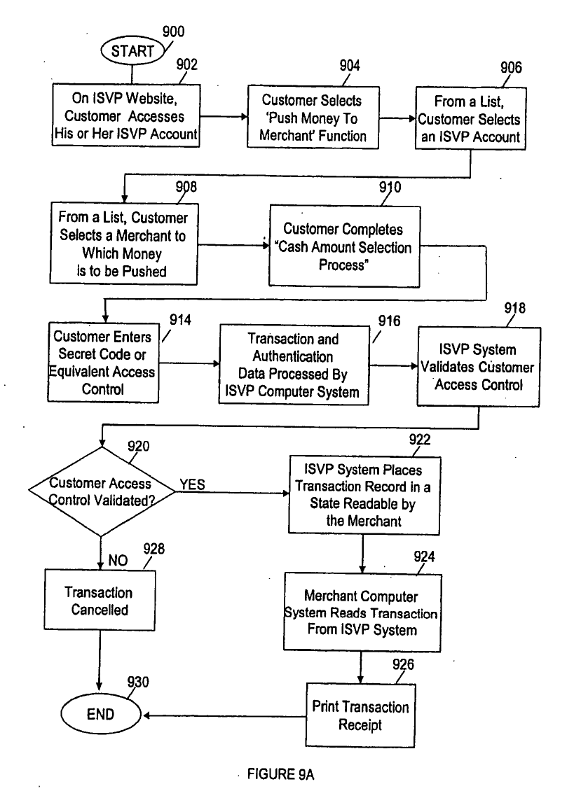

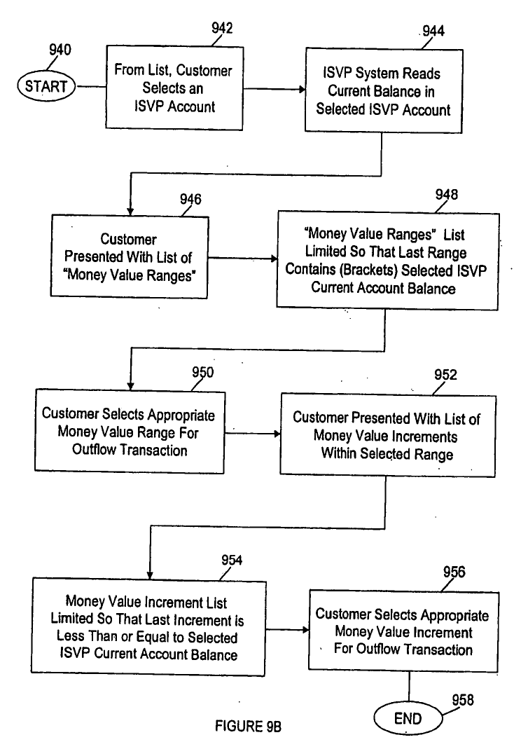

FIG. 9A is a flow diagram showing steps of an embodiment for moving money from a customer account to a merchant, according to the invention, starting at step 900. At step 902, a customer may access their account on an ISVP web site, typically using a browser. At step 904, the customer may select an option to “push money to a merchant,” which may be from among options provided by the web site for maintaining an account. At step 906, the customer may select an ISVP account, which may be from a list of customer accounts, from where money is to be taken. At step 908, the customer may select a merchant, such as from a list of merchants, to which the money is to be pushed. This may be for payment of a purchased item or service.

At step 910, the customer may complete a “Cash Amount Selection” process (e.g., process in reference to FIG. 9B). At step 914, the customer may enter a secret password or similar access control information (perhaps a biometric ID scan) for authentication. At step 916, the entered transaction (e.g., the merchant ID, selected ISVP account, cash amount, etc.) and authentication data (e.g., password or biometric data) may be processed by the ISVP system. At step 918, the ISVP system validates the customer access control information. At step 920, a check is made whether the customer access control is valid. If not valid, then at step 928, the transaction is cancelled, and the process ends at step 930.

If, however, the customer access control is valid, then at step 922, the ISVP system places a transaction record in a state readable by the merchant. At step 924, the merchant computer system reads the transaction record from the ISVP system. At step 926, a transaction receipt may be printed for the customer. At step 930, the process ends.

FIG. 9B is a flow diagram of an embodiment showing steps for cash amount selection process, according to the invention, starting at step 940. At step 942, a customer may select a customer account from a list (typically within a GUI) which may include multiple customer accounts. The list may be presented via an Internet session using a browser in concert with a web site server of an ISVP. At step 944, the ISVP system reads current balance information from ISVP secure databases for selected customer account. At step 946, the customer may be presented with a list of “money value ranges” in a first field of a GUI (e.g., one range may be $50.00-$100.00 and another $101.00-$150.00, and so forth). At step 948, the “money value ranges” list is limited so that no range is presented that exceeds the current customer's value for the selected account. The last range presented in the list may be highlighted, perhaps by brackets, for example, and contains the selected account balance within the range. In this way, the customer is presented with options (i.e., money value ranges) that do not exceed the current account balance level so that money transfers/selections are more concise and less error prone.

At step 950, the customer may select an appropriate money value range from the list for outflow transaction. At step 952, the customer may be presented in a second field with a list of money value increments with the range of the selected range. At step 954, the money increment list may be limited so that the last increment is less than or equal to the selected ISVP current account balance, thereby providing a safeguard against over drafting an account or misleading the customer about available funds. At step 956, the customer may select an appropriate money value increment for outflow transaction. At step 958, the process ends.

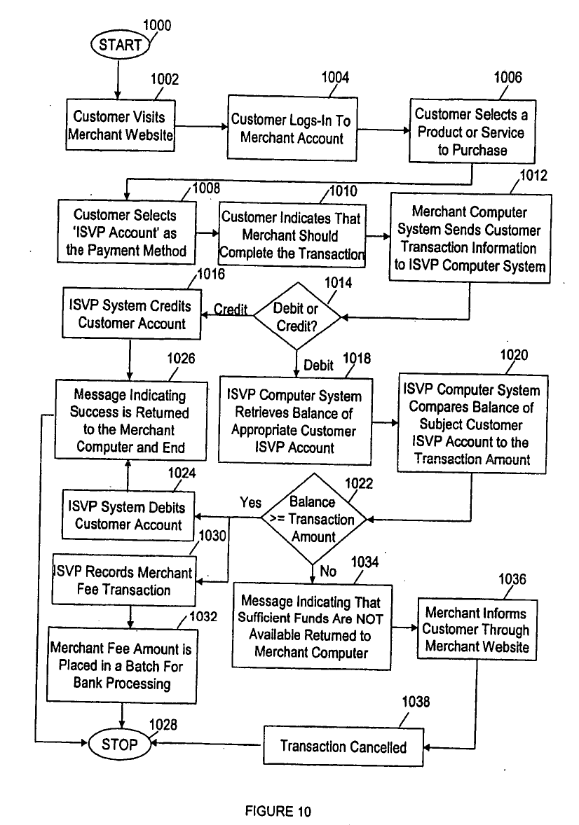

FIG. 10 is a flow diagram of an embodiment showing steps of moving money between a customer ISVP account and a merchant, starting at step 1000. At step 1002, the customer visits a merchant's website, typically using a browser. At step 1004, the customer logs-in to the customer's merchant account, if and when provided by a merchant. At step 1006, the customer may select one or more products or services to purchase. At step 1008, the customer selects an option to pay for the one or more products or services using an ISVP account as the payment method. Alternatively, the customer may be requesting a refund for a product or service.

At step 1010, the customer may indicate that the merchant may complete the transaction, using the customer's ISVP account as a payment source. At step 1012, the merchant's computer system sends the customer's transaction information to the ISVP computer system, typically over a network in a secured transmission mode which may include encrypting the customer's transaction information.

At step 1014, a check is made by the ISVP system as to whether this is a debit or credit type of transaction. If the transaction is a credit to the customer's account, perhaps due to a refund type of transaction, then at step 1016, the ISVP system credits the customer's account. Processing then continues at step 1026.

If, however, the check at step 1014 results in determining that a debit is necessary, then at step 1018, the ISVP system retrieves the balance of the appropriate customer's ISVP account, as previously selected by the customer. At step 1020, the ISVP system compares the balance amount to the transaction amount as associated with the transaction, as provided by the merchant computer system. At step 1022, a check is made to determine whether the current balance is equal to or greater than the transaction amount.

If the balance is not equal to or greater than the transaction amount, then at step 1034, a message may be sent to the merchant computer system indicating that sufficient funds are not available. At step 1036, the merchant informs the customer through the web site interface that the account has insufficient funds for the current transaction request. At step 1038, the current transaction is cancelled and the process stops at step 1028.

If, however, at step 1022, the balance is equal to or greater than the transaction amount, then two parallel flows begins. One parallel flow continues at step 1024 and the other parallel flow continues at step 1030.

Continuing with the first parallel flow at step 1024, the ISVP system debits the customer account for the amount of the transaction. At step 1026, a message may be returned to the merchant computer indicating success and end of transaction. This first parallel flow leg then stops, at step 1028.

Continuing with the second parallel flow at step 1030, the ISVP records the transaction and accounts for the merchant's fees. At step 1032, the merchant fee amount is placed in a batch (e.g., a database or file) for bank processing. At step 1028, the second parallel flow stops.

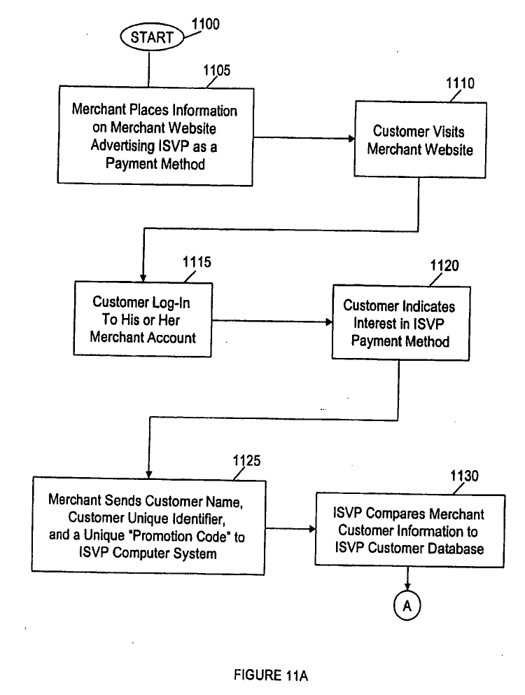

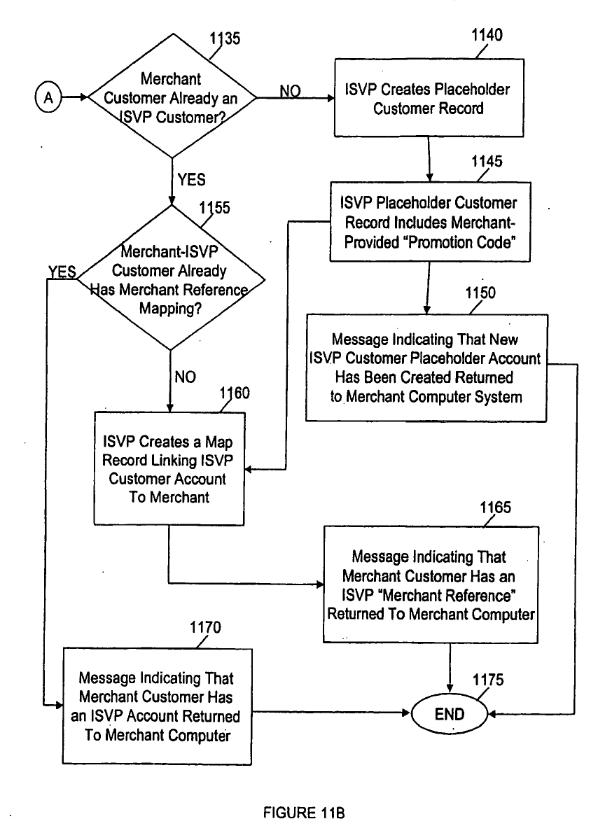

FIGS. 11A and 11B are flow diagrams of an embodiment showing steps of synchronizing a merchant customer account and an ISVP customer account, according to the invention, starting at step 1100. At step 1105, a merchant places information on a website advertising ISVP as a payment method for transacting a purchase. At step 1110, a customer visits the merchant website. At step 1115, the customer logs into (and/or establishes an account, if necessary) the customer's merchant account. At step 1120, the customer indicates interest in the ISVP payment service. At step 1125, the merchant sends the customer's name, a customer unique identifier and a unique “promotional code”, if appropriate, to the ISVP computer system.

At step 1130, the ISVP compares the merchant customer information to the ISVP customer database. At step 1135, a decision is made whether the merchant's customer is already an ISVP customer. If the merchant's customer is already an ISVP customer, then processing continues at step 1155. However, if not already an ISVP customer, then at step 1140, the ISVP creates a placeholder customer record. At step 1145 the ISVP placeholder record may be updated with the “promotion code.” The process continues with two parallel legs, one at step 1160 and the other parallel flow continues at step 1150.

Continuing with the first parallel flow at step 1150, a message may be returned to the merchant computer system indicating that the new ISVP customer placeholder account has been created. The first parallel flow ends at step 1175.

Continuing with the second parallel flow, at step 1160, the ISVP may create a map record linking the ISVP customer account to the merchant. At step 1165, a message may be sent to the merchant computer system indicating that the merchant's customer has an “ISVP merchant reference.” At step 1175, the second parallel flow ends.

Continuing the flow at step 1155, a check is made whether the merchant-ISVP customer already has a merchant reference mapping established. If not, then processing continues at step 1160, previously described. If however, a merchant reference mapping is already in place, then at step 1170, a message is sent to the merchant computer system indicating that the merchant customer has an ISVP account. The process ends at step 1175.

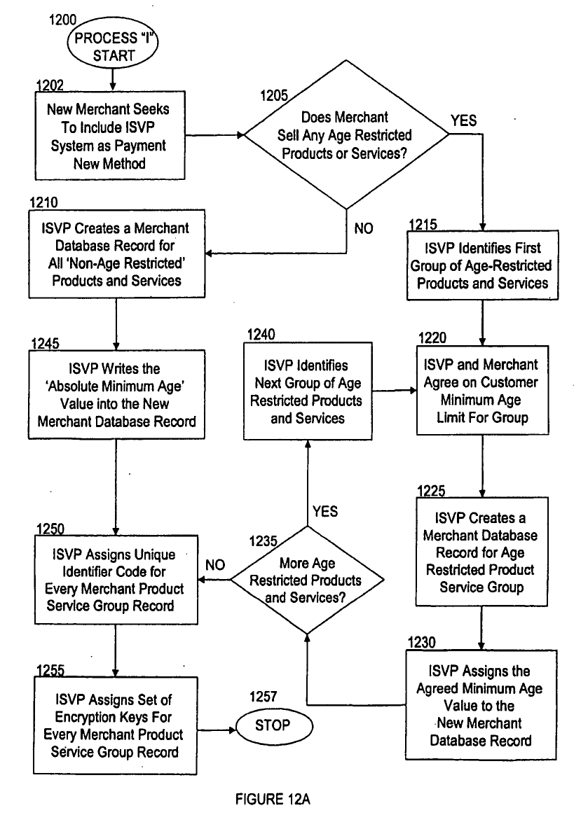

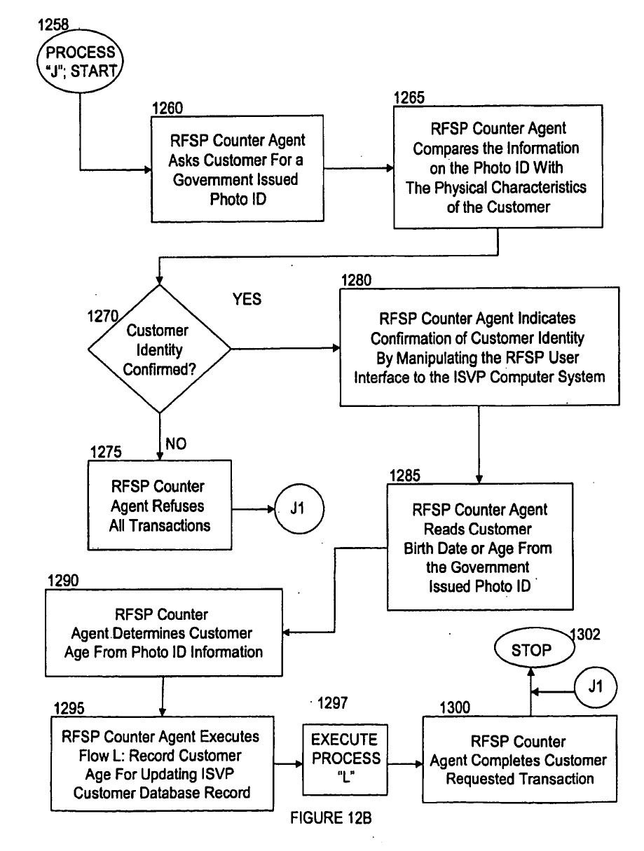

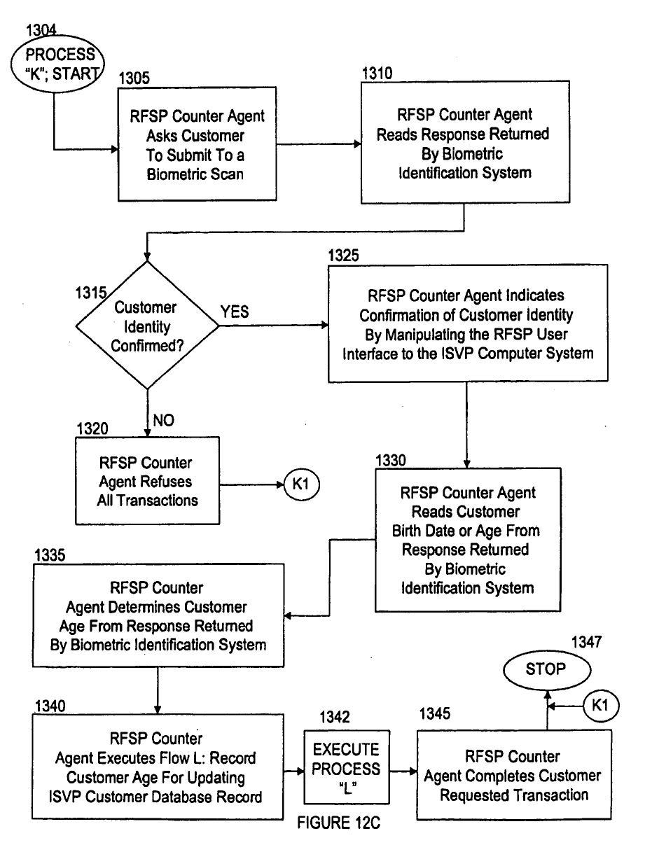

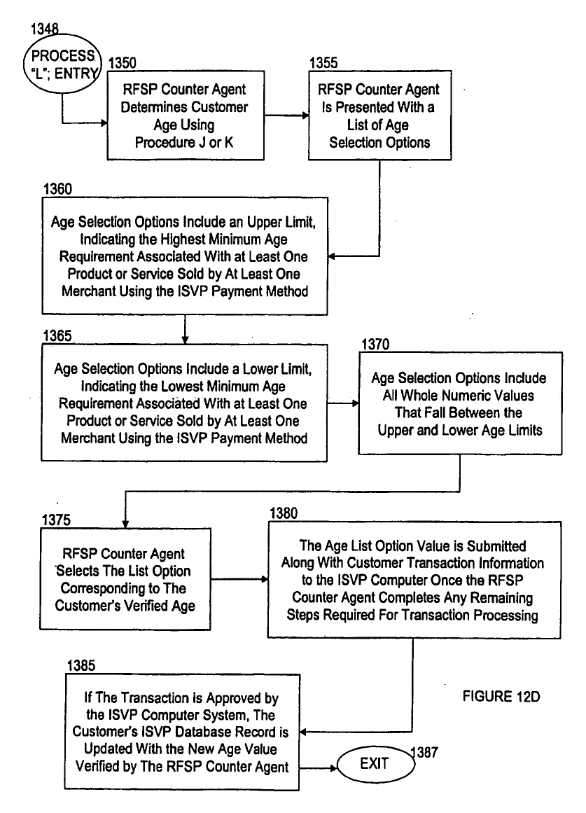

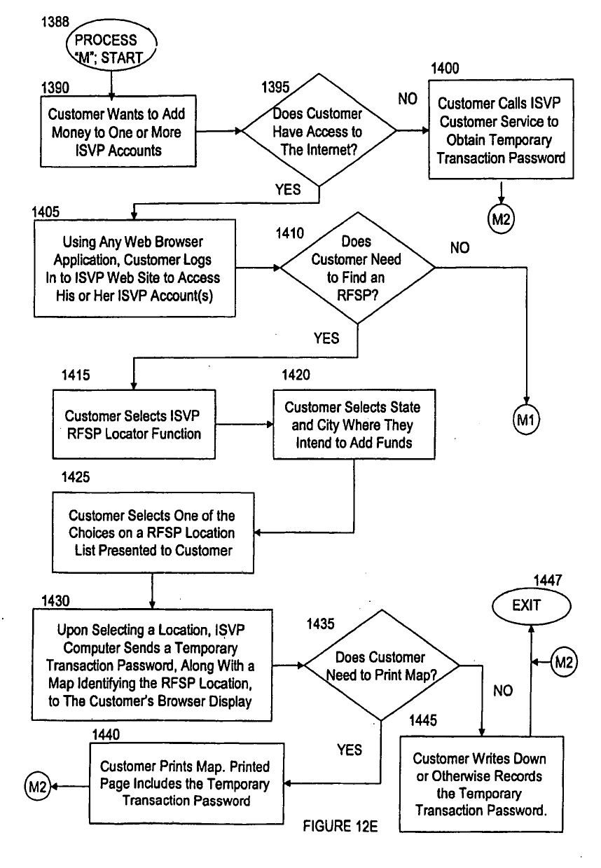

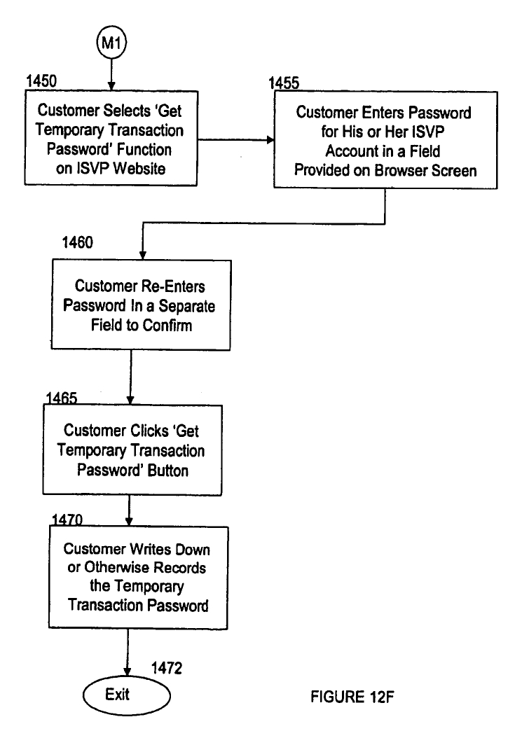

FIG. 12A is a flow diagram of an embodiment showing steps of establishing merchant information in an ISVP database, according to principles of the invention, starting at step 1200. It is preferable to ensure that any merchant selling age restricted products or services to sell those products or services only to customers of allowable age. In the “brick and mortar” economy, the process of reliably verifying someone's age is fairly straightforward. Even if a photo ID is counterfeit, a human person can infer someone's age by simply looking at them and judging relative age. Prior to the invention, such direct and reliable age verification has been impossible in an on-line economy. In embodiments, the system and method of the invention provides for human monitored verification of identity and/or age to establish a definitive basis of authorizing a transaction for on-line merchants for at least one individual transaction.

Continuing now with FIG. 12A, at step 1202, a merchant seeks to include the ISVP system as a “new method” of payment for commerce transactions. At step 1205, a check is made if the merchant sells any age restricted products or services. If the merchant does not offer age restricted products or services then, at step 1210 the ISVP creates a merchant database record for all “non-age” restricted products or services. At step 1245, the ISVP writes an “absolute minimum age” value into the new merchant database record indicating a minimum age for purchases. At step 1250, the ISVP assigns a unique identifier code for every merchant product service group record. At step 1255, the ISVP assigns a set of encryption keys for every merchant product service group record, i.e., for every group of products or services requiring a minimum age (which may be a different age among different product or service groups). At step 1257, the process ends.

If, however, at step 1205, the merchant does sell age restricted products of services, then at step 1215, the ISVP identifies a first group of restricted products or services. At step 1220, the ISVP and merchant agree on customer minimum age limit for the particular group. At step 1225, the ISVP creates a merchant database record for the age restricted product service group. At step 1230, the ISVP assigns the agreed minimum age value to the new merchant database record. At step 1235, a check is made to determine if there are more age restricted products or services. If so, then at step 1240, the ISVP identifies a next group of age restricted products and/or services. The process then continues with step 1220. If, however, at step 1235, there are no more age restricted products or services, then processing continues with step 1250.

FIG. 12B is a flow diagram of an embodiment showing steps of customer identity and age verification, according to principles of the invention, starting at step 1258. The context of process “J” of FIG. 12B (and also process K of FIG. 12C) describe exemplary variations of procedures that may be followed by an RFSP agent in the course of verifying a ISVP customer's age and identity. The procedures are presented in the context of a customer entering the physical RFSP location and approaching the counter agent to initiate a transaction, such as adding money or taking money out of an account. In these examples, a human-to-human element of identification is maintained by the invention.

At step 1260, an RFSP agent may ask for a government issued ID, typically with a photo of the customer, in order to attempt to confirm the identity of a customer when the customer is requesting a transaction to be performed, such as, for example, depositing of funds into an account. At step 1265, the RFSP agent compares the information on the ID with physical characteristics of the customers. At step 1270, a determination is made whether the customer's identity is deemed confirmed. If not deemed confirmed, then at step 1275, the agent refuses all transactions. The process ends at step 1302.

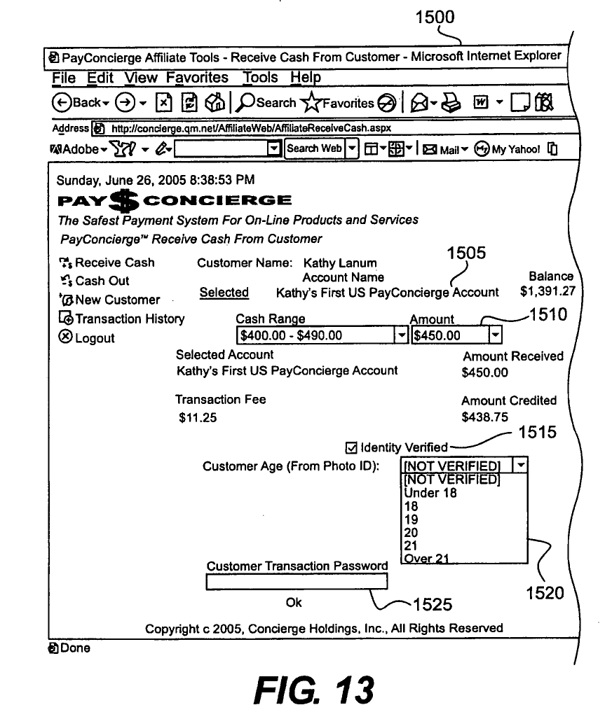

If, however, at step 1270, the customer's identity is deemed confirmed, then at step 1280, the RFSP counter agent indicates confirmation of the customer identity by manipulating the RFSP user interface (e.g., interface of FIG. 13) to the ISVP system. At step 1285, the RFSP agent reads the customer's birth date or age from the government issued ID. At step 1290, the RFSP agent determines the customer's age from the governmental issued ID. At step 1295, the RFSP agent may initiate recording the customer's age for updating ISVP customer database record. At step 1297, execution of customer age update occurs (see process “L” of FIG. 12D). At step 1300, the RFSP counter agent completes customer requested transaction such as a deposit or inquiry, for example. The process ends at step 1302.

FIG. 12C is a flow diagram of an embodiment showing steps of a counter agent customer identity age verification procedure using biometrics, according to principles of the invention, starting at step 1304. At step 1305, the RFSP agent asks a customer to submit to a biometric scan, such as, but not limited to, a fingerprint scan, an eye scan, a voiceprint scan and/or a facial recognition scan. At step 1310, the RFSP agent reads the response returned by the biometric identification system. The biometric identification system having compared the current scan information with previously stored biometric scan information of the customer. In embodiments, the biometric system may be a part of the ISVP system or in communication with an independent biometric system. An indication that a biometric verification has been performed may be included in the customer records and conveyed as appropriate to control a transaction. At step 1315, a determination is made whether the customer's identity is confirmed. If not deemed confirmed, then at step 1320, the RFSP agent refuses all transactions. The process ends at step 1347.

If, however, the customer's identity is deemed confirmed at step 1315, then at step 1325, the RFSP agent indicates confirmation of the customer's identity by manipulating the RFSP user interface (e.g., the interface of FIG. 13) to the ISVP computer system. At step 1330, the RFSP agent reads the customer's birth date or age from the response returned from the biometric identification system. At step 1335, the RFSP counter agent determines the customer's age from the response returned from the biometric identification system. It should be understood that the biometric system has previously been initialized with data associated with the customer including biometric data, age and other personal information.

At step 1340, the RFSP agent initiates updating the ISVP customer database record for the customer's age, as described in relation to process “L” of FIG. 12D, and in view of the examples of FIG. 13. At step 1342, process “L” of FIG. 12D is executed. At step 1345, the RFSP counter agent completes the customer transaction as requested by the customer. At step 1347, the process ends.

FIG. 12D is a flow diagram of an embodiment showing steps of updating ISVP customer database record, according to principles of the invention, starting at step 1348. FIG. 12D may be viewed in relation to the examples of FIG. 13. At step 1350, the RFSP agent determines the customer age using process “J” or “K”, if not already done. At step 1355, a list of age selection options is presented to the RFSP agent. At step 1360, the age selection options include an upper limit, indicating the highest minimum age requirement associated with at least one product or service provided by at least one merchant using the ISVP payment system and process. At step 1365, the age selection options include a lower limit, indicating the lowest minimum age requirement associated with at least one product or service provided by the at least one merchant using the ISVP payment system and process.

At step 1370, the age selection options may include one or more whole numeric values that fall between the upper and lower age limits. At step 1375, the RFSP agent selects the list option corresponding to, or indicative of, the customer's verified age. At step 1380, the selected age list option value is submitted along with the customer's transaction information to the ISVP computer system once the RFSP counter agent completes any remaining transaction related activity. At step 1385, if the transaction is approved by the ISVP computer system, the customer's ISVP database record is updated with the new age value verified by the RFSP counter agent. At step 1387, the process ends. As provided by the exemplary process and components of FIG. 12D, the system and method of the invention provides a proxy verification service whereby a customer's age is positively verified on behalf of an on-line merchant according to an age limitation requirement for a product or service being purchased or acquired.

FIGS. 12E and 12F is a flow diagram of an embodiment showing steps for a customer procedure to obtain a temporary transaction password, according to the principles of the invention, starting at step 1388. At step 1390, a customer may wish to add money to one or more ISVP accounts. At step 1395, a determination is made whether the customer has Internet access. If not, the customer may call an ISVP customer service to obtain a temporary transaction password which is typically used one time to achieve a transaction. If, however, the customer does have access to the Internet, then at step 1405, using any suitable web browser application, the customer may log into a ISVP web site to access his or her ISVP account(s). At step 1410, a check is made whether the customer needs to locate a RFSP. If not, processing continues with step 1450 (FIG. 12F). If, however, the customer needs to find a RFSP, then at step 1415, the customer selects a ISVP RFSP locator function. At step 1420, the customer may select a state and city (maybe by zip code) where they intend to add funds. At step 1425, the customer selects one of the choices presented to the customer on a RFSP location list. At step 1430, upon reception of a selection, the ISVP computer system sends a temporary transaction password, possibly along with a map identifying the RFSP location, to the customer's browser display. At step 1435, a check is made to determine if the customer wishes to print the map. If so, then the map and temporary transaction password is printed and the process ends at step 1447. If, however, the customer does not request a map, the customer may write down the temporary password, or otherwise records the temporary transaction password. At step 1447 the process ends.

Continuing with step 1450 (from the decision block of step 1410) of FIG. 12F, the customer selects a “Get a Temporary Transaction Password” function on the ISVP web site. At step 1455, the customer enters a temporary password for her or his ISVP account in a field provided on the browser screen. At step 1460, the customer re-enters the password in a separate field to confirm the password. At step 1465, the customer clicks “Get Temporary Password” button. At step 1470, the customer writes down or otherwise records, the temporary transaction password for “one-time” use at the RFSP when transacting business.

FIG. 13 is an is illustration of a portion of an interface provided by the ISVP for various functions including identity and age verification, generally denoted by reference numeral 1500. The interface 1500 may be used by a RFSP counter agent when receiving money from an ISVP customer to deposit funds to a SVA account, perhaps for paying for a purchase. The interface includes an account field 1505 that provides feedback as to the selected customer account. The interface 1500 provides for selecting one account from possible multiple accounts that the ISVP customer may have. The interface 1500 also includes a cash amount selection facility 1510, in this example, comprising two parts: a cash range drop down and an amount selection field. The two part facility provides for reduced keying errors by prompting for a cash range to limit the money range, then the amount selection field provides for selecting a specific money amount within the selected cash range. This two part facility may be used throughout the ISVP system to provide a consistent user interface and to minimize errors in transactions by reducing key strokes and mistyped entries, e.g., perhaps the decimal point in wrong position. The cash range may also be flexible in range sizes and total number of range selections based on type of account or pre-determined account parameter, such as a per customer setting.

Interface 1500 also includes an Identity Verified indicator 1515 which the counter agent checks when proper identification has been presented for confirmation by the customer to the counter agent. This may occur substantially at the time of completing a purchase of a product or service. Typically, the identification is a photo-ID, and is usually government issued or sanctioned. This human confirmation of customer identity at the time of deposit provides substantial confidence that the depositor is the actual customer and reduces fraudulent usage of money and misuse of the ISVP system. Interface 1500 further includes a drop down selection 1520 that enables the counter agent to confirm the age of the customer based on the customer ID. Alternatively, in other embodiments, the birth date may be entered by the counter agent as listed on the customer ID and software computes the current age by comparing the birth date to the current time and date to generate a difference and, hence, the age of the customer. The age is maintained in a database record associated with the customer which may be used to control (e.g., grant or deny) age-restricted purchases of products and services by making the age information available to system merchants, typically on a per purchase basis, often substantially at the time of purchase. The birth date is not permanently maintained. By computing and storing the age at the time of the money deposit, actual personal data, e.g., the actual birth date itself in this example, is not required to be stored by the system. Since the actual birth date is not stored, this data cannot be compromised thereby making the overall transactional functionality of the system more secure.

Interface 1500 may also include a temporary transaction password field 1525. The customer presents the temporary password to the RFSP counter agent for authenticating the transaction. The temporary password was previously provided to the customer typically during an on-line session or by telephone, e.g. when purchasing a product or service. Once used, the temporary password is typically discarded.

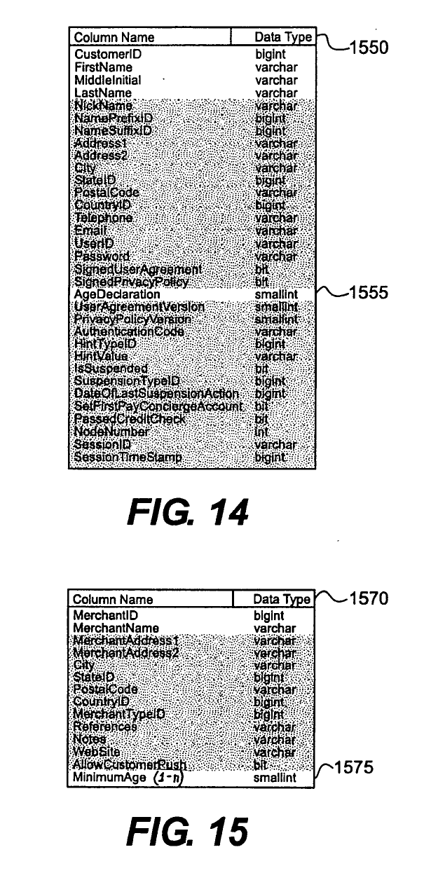

FIG. 14 is an exemplary illustration of a customer record maintained by the ISVP system, generally denoted by reference numeral 1550. The customer record includes basic customer information such as, for example, name, address, customer ID, a password for accessing the SVA account, a UserID, other contact information and account control parameters such as user agreement version, suspended status, passed credit check, node number in system, email address, network or IP address, etc. Also included it the customer database record 1550 is a “Age Declaration” field that stores the age (typically a cardinal or whole number) of the customer, or alternatively, indicates that the customer is of an Acceptable Age or is Not of an Acceptable Age. An actual date of birth not stored. The criteria of acceptable being selectable by the system operators based on business operations. Alternatively, in other embodiments, multiple age indicators may be used and associated with types of products or product categories. For example, tobacco purchases may required age 18, while wine purchases may require age 21.

Conveying the “Age Declaration” field may be initiated, as needed, to one or more merchants by electronic message or by database record updates. The message or database updates may contain one or more codes including one or more of the customer information data elements of customer record 1550. The electronic signal may also bear a transaction amount.

FIG. 15 is an exemplary illustration of a merchant record, generally denoted by reference numeral 1570. The merchant record 1570 includes basic information about the merchant such as, but not limited to, a merchant identifier, merchant name, merchant address, allow customer push indicator, and one or more minimum age values (1-n) 1575 that indicates an age that a customer must be in order to buy a product or a service from the merchant. For example, a customer may be required to be at least 21 to buy alcohol, while for tobacco age 18 may be required. This minimum age field is compared with the “Age Declaration” field provided by the customer record 1550 during transactions to confirm minimum age requirements prior to completing a transaction. Multiple minimum age fields (1-n) 1575 may be employed and arranged to indicate different types of products or services that have different age requirements. For example, one of the multiple age fields (1-n) 1575 can represent a particular product category or a product type, while another multiple age field may represent the minimum age for a different product (or service). It is possible to also set up age restriction requirements to include transactional decision making based on geographical location of the customer and/or merchant. For example, if both merchant and customer are located or operating in a state where a product or service has a different age limit from other states, then this information may be factored into the decision making and also into the database records, as appropriate. For example, another one of the multiple age fields (1-n) may represent geographical minimum age requirement, perhaps by a specific product type or service. Each of the merchant records may be flexibly configured to refer to a product, a service, a range of products or a range of services offered by the merchant customer that includes a data element indicating a minimum consumer age required to complete a purchase.

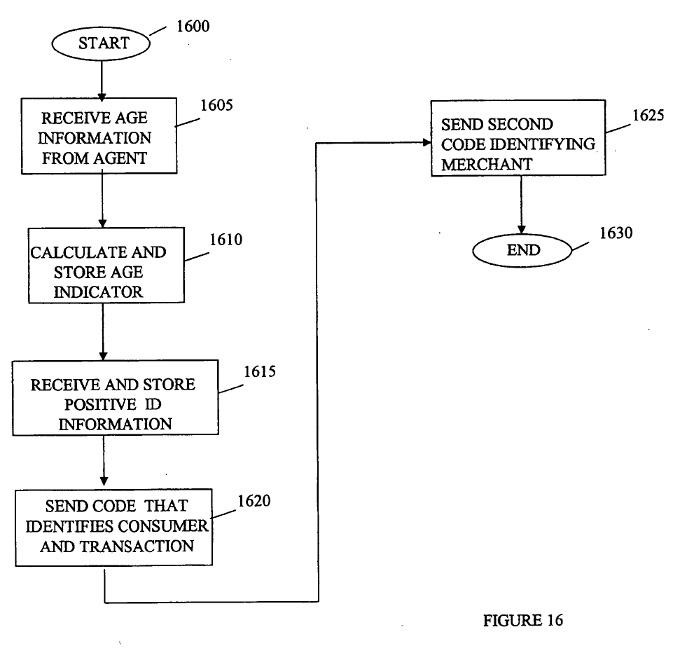

FIG. 16 is a flow diagram of an embodiment showing steps for receiving and communication information in the system, beginning at step 1600. At step 1605, the counter agent identifies age information from a customer's identification document, typically a government-type issued document having a photo of the consumer and enters the age information as either a age or by birth date for computing an age indicator, such a minimum age has been attained, or age itself. A biometric scan may also be performed. At step, 1610, the age indicator and/or an indication that the biometric scan has been performed are stored and maintained, typically in the customer's associated database record. The actual birth date of the consumer is not maintained. At step 1615, the consumer's identity is verified by a human agent, typically using a photo ID issued by a government institution, and an indication is provided to the system that the identity has been verified. At step 1620, an electronic code is sent that includes identification of the consumer and transaction information identifying the transaction and may include a money amount. This information may be sent as necessary to the merchant and/or to a database for updating of the customer records. A email or IP address may be included in the message for aiding to identify the consumer. At step 1625, a second code may be sent that identifies a merchant that should be compensated for the transaction. At step 1630, the process ends.

### USING THE INVENTION

The invention may be deployed so that merchants may offer services and/or products that have age restriction requirements and/or require positive identification of the consumer. For example, tobacco, alcohol, adult restricted materials such as magazines and movies, legalized on-line gambling or any other sales restricted product or service may be control by the invention so that verification of the consumer's age is achieved prior to completion of a transaction. The consumer's age information is also protected since the actual birth date information is not required to be maintained as part of the system. Rather, an indication that a particular age or a minimum has been reached is maintained.

The invention may also be used to control differing types of services or products that may require other types of verified data such as a federal or state license to operate or buy a controlled device or substance such as, for example, a medical device, a controlled substance, a commercial radio transmitter or perhaps a amateur radio license. Another example is when a restaurant wants to purchase liquor on-line. In this example, the restaurant would be required to demonstrate that they have a valid license to the counter agent prior to paying for or completing the transaction. The merchant record and customer record can indicate that these different types of verified data (i.e., a license or permit) is required by type to finalize a transaction and that a human agent must verify the license or permit by type. The customer record can then be updated as described previously herein to indicate that the specific type of verification (e.g., liquor license or radio license) has actually been verified by human inspection. This information is conveyable as appropriate across the system, typically by electronic message or database record update.

In the course of customer identity verification at the RFSP, various types of biometric authentication may be necessary, perhaps depending on the type of product or service being purchased or a requirement issued by the ISVP system or even by a particular merchant. For example, a fingerprint may be required to purchase a particular product from one merchant, while a retina scan may be necessary to purchase a different product and/or from a second merchant. Furthermore, geographic location of the customer and/or merchant may impose identification requirements (e.g., different biometric checks) or age verification limitations that are different from one locality than another, which may be flexibly managed by the ISVP system.

The system of the invention improves the ability of society to impart better sales controls over restricted products. Moreover, the system may provide an improved overall solution to transact business so that sensitive consumer information such as social security information, credit card information, birth dates are not maintained by the system for processing and completing a transaction. This is particularly important when viewed in the context of the current on-line transaction activities in use prior to the invention which are prone to security breaches and compromised sensitive personal data such as social security numbers, credit card numbers and birth dates. Moreover, the human verified authentication process provides for ongoing confirmation of the identity of the consumer to avoid misuse of the system or unauthorized (and potentially illegal) money transactions.

While the invention has been described in terms of embodiments, those skilled in the art will recognize that the invention can be practiced with modifications and in the spirit and scope of the appended claims.

What is claimed is:

1. A computer-implemented method for selecting money amounts for a money transaction, comprising the steps of:
presenting a first list having a plurality of money ranges;
receiving a selection of one money range from the plurality of money ranges;
presenting a second list having a plurality of money value increments wherein the plurality of money value increments are within the selected one money range; and
receiving a selection of one money value increment from the plurality of money increments for facilitating a money transaction.

2. The computer-implemented method of claim 1, wherein said step for presenting a first list includes limiting the first list so that a last presented money range from the plurality of money ranges contains a maximum amount in a customer account.

3. The computer-implemented method of claim 2, further comprising the step of crediting or debiting the selected money value increment in the customer account.

4. The computer-implemented method of claim 1, further comprising the steps of:
receiving an indication that the identity of a customer has been verified;
receiving an indication that the age of the customer has been verified; and
initiating transmission of both indications to at least one merchant to authorize a transaction.

5. A method of controlling on-line sale of an age-restricted product or service, comprising the steps of:
receiving at an on-line merchant a request for a purchase of the age-restricted product or service;
receiving at the merchant an indication that the identity of a consumer initiating the request has been verified by a authorized human agent based on at least a governmentally sanctioned identification document; and
fulfilling the request based on the indication.

6. The method of claim 5, further comprising the steps of:
obtaining information prior to the fulfilling step that the attained age of the consumer is sufficient for the requested purchase, wherein the attained age is verified against at least a birth date on the governmentally sanctioned identification document as supplied to the authorized human agent.

7. The method of claim 6, wherein the indication also includes that the identity has been verified by biometrics.

8. An age verification system to facilitate transactions of an age-restricted product or service involving an Internet payment processing business, comprising:
a first software module configured to receive age information from a human agent;
a second software module that stores an age indicator of the consumer in a database record associated with the consumer; and
a third software module that initiates transmission of an electronic signal including a first code identifying the consumer and an amount of a transaction, wherein the first code identifying the consumer also provides information for retrieving the database record to access the age indicator, wherein the age indicator is used to grant or deny the transaction of the age-restricted product or service.

9. The age verification system of claim 8, wherein the first software component calculates an age to produce the age indicator from the age information by calculating a difference between the birth date of the consumer as entered by the human agent from at least a government sanctioned identification instrument and the date and time of the calculation.

10. The age verification system of claim 8, wherein the first code includes a network address.

11. The age verification system of claim 8, wherein the electronic signal further includes a second code that identifies a merchant to receive payment for said transaction.

12. The age verification system of claim 8, wherein the electronic signal further includes a second code that aids in identifying the age-restricted product or service.

13. The age verification system of claim 8, further comprising a fourth software module that manages database records for a merchant customer of the Internet payment processing business, wherein each database record that refers to one of a product, a service, a range of products, and a range of services offered by the merchant customer includes a data element indicating a minimum consumer age required to complete a purchase.

14. The age verification system of claim 13, wherein at least one of the first, second, third and fourth software component is maintained by or on behalf of the Internet payment processing business.

15. The age verification system of claim 8, wherein the age information indicates a current age of the consumer.

16. The age verification system of claim 8, wherein the age verification system does not store and maintain a credit card number, a social security number, and a birth date of the consumer.

17. A system for verifying and managing data in an on-line commerce system, comprising:
means for issuing a prompt for a money value range and receiving a selection in response to the prompt to facilitate payment of an on-line purchase, wherein the prompt includes a plurality of money ranges;
means for receiving input indicating positive identification of a purchaser of the on-line purchase, wherein the positive identification indicates that verification by a human agent as to the identity of the purchaser has been performed; and
means for initiating communication of information to an on-line merchant that the identity of the purchaser has been positively verified for authorizing completion of the on-line purchase.

18. The system of claim 17, further comprising means for receiving a specific money value amount within the selected one of the plurality of money ranges.

19. The system of claim 17, wherein the plurality of money ranges has an upper limit less than or equal to an account balance associate with the purchaser.

20. The system of claim 17, further comprising:
means for receiving input indicating the age of the purchaser; and
means for initiating communication of information indicative of the age for use by on-line merchants to authenticate the on-line purchase that requires age verification.

21. The system of claim 20, wherein the information indicative of the age is communicated as a whole number and not a date.
